(19) United States
(12) Patent Application Publication
(10) Pub. No.: US 2009/0135294 A1
(43) Pub. Date: May 28, 2009

(54) FOCUS CONTROL APPARATUS AND FOCUS CONTROL METHOD

(75) Inventors: Jun HIRAI, Tokyo (JP); Sunao Aoki, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 12/268,644

(22) Filed: Nov. 11, 2008

(30) Foreign Application Priority Data
Nov. 26, 2007 (JP) 2007-304631

(51) Int. Cl. H04N 5/232; G03B 13/32

(52) U.S. Cl. 348/357; 348/E05.042

(57) ABSTRACT

A focus control apparatus conducts a focus control with respect to an imaging apparatus configured to vary the focal point using a deformable mirror. An imaging unit first obtains image data via imaging elements and imaging optics provided in the imaging apparatus. A controller controls the driving of the deformable mirror such that, during a first image reading period wherein the reading of an image signal is periodically executed by means of the imaging elements, a focus drive state is achieved whereby an in-focus point that has been found in advance is set as the current focal point. During a second image reading period different from the first image reading period, the deformable mirror is controlled so as to achieve a focus drive state for in-focus point search.

### CROSS REFERENCES TO RELATED APPLICATIONS

The present invention contains subject matter related to Japanese Patent Application JP 2007-304631 filed in the Japanese Patent Office on Nov. 26, 2007, the entire contents of which are incorporated herein by reference.

### BACKGROUND OF THE INVENTION

1. Field of the Invention

The present invention relates to a focus control apparatus and method for conducting a focus control with respect to an imaging apparatus configured to vary the focal length using a deformable mirror whose cross-sectional shape is deformable to convex or concave curvature.

2. Description of the Related Art

In the related art, video camera devices that record video footage typically conduct autofocus by searching for an in-focus point using a hill climbing technique. When a hill climbing technique is implemented in this way as the technique for searching for an in-focus point, the focal point is shifted to search for an in-focus point even while recording footage. For this reason, there is a problem in that footage becomes defocused while recording. In particular, a subject may become defocused when recording footage using a video camera device that has been affixed to a tripod or similar means, even though the distance to the subject is not being varied. The above results in pronounced unnaturalness.

Meanwhile, it is currently typical to set the focal point by driving a focus lens using a motor. However, because the devices of the related art conduct in-focus point search even while recording footage as described above, there is a problem in that motor noise is also recorded as part of the recorded data.

As an example of technology that attempts to resolve this latter problem of motor noise, JP-A-2004-170637 discloses a camera apparatus configured using a deformable mirror as the focusing means. The apparatus disclosed in JP-A-2004-170637 is provided with a deformable mirror (i.e., a variable-shape mirror) as part of the imaging optics thereof. The focal point is adjusted by deforming the mirror surface to concave curvature. The deformable mirror includes a thin-film coating of aluminum or similar substance that acts as the mirror surface, as well as electrodes provided facing each other behind the thin film. When driving the mirror, voltage is applied to the electrodes, thereby producing a difference in electrical potential between the grounded mirror surface of aluminum or similar substance and the electrodes. The resulting Coulomb force causes the thin film to be drawn toward the electrodes, thereby causing the thin film (i.e., the mirror surface) to deform to concave curvature. By using a deformable mirror like the above, it is possible to resolve the problem of noise such as that caused when driving the focus lens with a motor.

### SUMMARY OF THE INVENTION

However, even when the technology disclosed in the above JP-A-2004-170637 is applied to a video camera apparatus, the problem of recording unfocused footage is not resolved, due to the implementation of a hill climbing technique as the technique for in-focus point search. The application of the technology disclosed in JP-A-2004-170637 is only assumed for still images, and thus even if a camera implementing the above technology conducts in-focus point search using a hill climbing technique, only already-focused images are recorded. For this reason, the problem of unfocused video footage being recorded does not occur in this case.

In contrast, in the present invention it is desirable to provide technology to be implemented in a system for recording video footage, wherein the recording of unfocused video footage that accompanies in-focus point search using a hill climbing technique in particular is prevented.

Consequently, a focus control apparatus in accordance with an embodiment of the present invention is configured like the following.

A focus control apparatus in accordance with an embodiment of the present invention conducts a focus control with respect to an imaging apparatus configured to vary the focal point using a deformable mirror, provided as part of the imaging optics thereof, whose cross-sectional shape is deformable to convex or concave curvature. The focus control apparatus includes imaging means for obtaining image data that has been imaged as a result of imaging elements detecting an image formed via the imaging optics. In addition, the focus control apparatus includes control means for conducting a drive control with respect to the deformable mirror. During a first image reading period, wherein the reading of an image signal is periodically executed by means of the imaging elements, the control means controls the driving of the deformable mirror so as to achieve a focus drive state whereby an in-focus point that has been found in advance is set as the current focal point. During a second image reading period different from the first image reading period, the control means controls the driving of the deformable mirror so as to achieve a focus drive state used for in-focus point search.

In addition, a focus control method in accordance with an embodiment of the present invention is configured like the following.

A focus control method in accordance with an embodiment of the present invention is used to conduct focus control with respect to an imaging apparatus configured to vary the focal point using a deformable mirror, provided as part of the imaging optics thereof, whose cross-sectional shape is deformable to convex or concave curvature. The focus control method includes the following steps. During a first image reading period, wherein the reading of an image signal is periodically executed by means of imaging elements that detect an image formed via the imaging optics, the driving of the deformable mirror is controlled so as to achieve a focus drive state whereby an in-focus point that has been found in advance is set as the current focal point. During a second image reading period different from the first image reading period, the driving of the deformable mirror is controlled so as to achieve a focus drive state used for in-focus point search.

According to an embodiment of the present invention, the reading of an image that has been imaged by the imaging elements is separated into a second image reading period, wherein an image signal is read in order to find an in-focus point, and a first image reading period, wherein an image is read in a state wherein an in-focus point that has been found is set as the current focal point.

Herein, as a result of the deformable mirror, the focal point can be adjusted simply by causing the mirror surface of the deformable mirror to deform to convex or concave curvature. For this reason, drive signal response can be made to be extremely rapid compared to the configuration of the related art wherein the focal point is adjusted by using a motor to drive a focus lens. Consequently, the focus state can be rapidly switched when switching the focus drive state between that of the first image reading period and the second image reading period. As a result, operations to switch the focus drive state and read images for the respective periods described above can be suitably performed.

By using a deformable mirror as described above, it is possible to separately read an image signal in a focused state (i.e., during the first image reading period) and an image signal used to find an in-focus point (i.e., during the second image reading period). Consequently, the image signal read during the second image reading period may be used exclusively for in-focus point search, while the image signal read during the first image reading period may be used exclusively for recording footage. In so doing, it becomes possible to prevent recording defocused footage occurring because the focal point is being varied as part of an in-focus point search process that implements a hill climbing technique, for example.

According to an embodiment of the present invention, the recording of defocused video footage that accompanies in-focus point search is prevented in a system that records video footage as a result of separating the reading of the image signal by switching between the respective focus drive states of a first image reading period and a second image reading period. Moreover, the recording of defocused video footage is prevented even in the case where such a system implements a hill climbing technique for in-focus point search.

### BRIEF DESCRIPTION OF THE DRAWINGS

FIG. 1 is a block diagram illustrating the internal configuration of an imaging apparatus in accordance with a first embodiment of the present invention;

FIG. 2 is a block diagram illustrating the internal configuration of a signal processor provided in an imaging apparatus in accordance with an embodiment of the present invention;

FIG. 3 is a cross-section view illustrating the configuration (in the non-deformed state) of a deformable mirror apparatus provided in an imaging apparatus in accordance with an embodiment of the present invention;

FIG. 4A is a diagram illustrating the configuration of a flexible member provided in a deformable mirror apparatus in accordance with an embodiment of the present invention;

FIG. 4B is a diagram illustrating the configuration of a flexible member provided in a deformable mirror apparatus in accordance with an embodiment of the present invention;

FIG. 5 is a diagram for explaining the spot shape of subject light on the mirror surface of a deformable mirror apparatus in accordance with an embodiment of the present invention;

FIG. 6 is a diagram for explaining an exemplary method for manufacturing a deformable mirror apparatus in accordance with an embodiment of the present invention;

FIG. 7 is a cross-section view illustrating the configuration (in the concave state) of a deformable mirror apparatus in accordance with an embodiment of the present invention;

FIG. 8 is a cross-section view illustrating the configuration (in the convex state) of a deformable mirror apparatus in accordance with an embodiment of the present invention;

FIG. 9A is a diagram for explaining focus control operation in accordance with a first embodiment of the present invention;

FIG. 9B is a diagram for explaining focus control operation in accordance with a first embodiment of the present invention;

FIG. 10 is a diagram for explaining the read region of imaging elements;

FIG. 11 is a block diagram illustrating the internal configuration of a shutter time control processor provided in an imaging apparatus in accordance with an embodiment of the present invention;

FIG. 12A is a diagram for explaining the control characteristics of a feedback quantity that depends on a specified shutter time;

FIG. 12B is a diagram for explaining the control characteristics of a feedback quantity that depends on a specified shutter time;

FIG. 12C is a diagram for explaining the control characteristics of a feedback quantity that depends on a specified shutter time;

FIG. 13 is a flowchart illustrating processing operations to be executed according to the image reading period for an in-focus point search field, such processing operations being executed in order to realize focus control operations in accordance with the first embodiment of the present invention;

FIG. 14 is a flowchart illustrating processing operations to be executing according to the image reading period for a recording field, such processing operations being executed in order to realize focus control operations in accordance with the first embodiment of the present invention;

FIG. 15A is a diagram for explaining focus control operations in accordance with a second embodiment of the present invention;

FIG. 15B is a diagram for explaining focus control operations in accordance with a second embodiment of the present invention;

FIG. 16A is a diagram for explaining a focus control mode defined in an imaging apparatus in accordance with the second embodiment of the present invention;

FIG. 16B is a diagram for explaining a focus control mode defined in an imaging apparatus in accordance with the second embodiment of the present invention;

FIG. 16C is a diagram for explaining a focus control mode defined in an imaging apparatus in accordance with the second embodiment of the present invention;

FIG. 16D is a diagram for explaining a focus control mode defined in an imaging apparatus in accordance with the second embodiment of the present invention;

FIG. 17 is a diagram for explaining a technique used to set (i.e., switch among) respective modes;

FIG. 18 is a block diagram illustrating the internal configuration of an imaging apparatus in accordance with the second embodiment of the present invention;

FIG. 19 is a flowchart illustrating processing operations to be executed in order to switch among respective modes, such processing operations being executed in order to realize focus control operations in accordance with the second embodiment of the present invention; and

FIG. 20 is a flowchart illustrating processing operations to be executed in order to realize the operations of respective modes, such processing operations being executed in order to realize focus control operations in accordance with the second embodiment of the present invention.

### DESCRIPTION OF THE PREFERRED EMBODIMENTS

Hereinafter, preferred embodiments for realizing the present invention will be described.

### First Embodiment

### (Internal Configuration of the Imaging Apparatus)

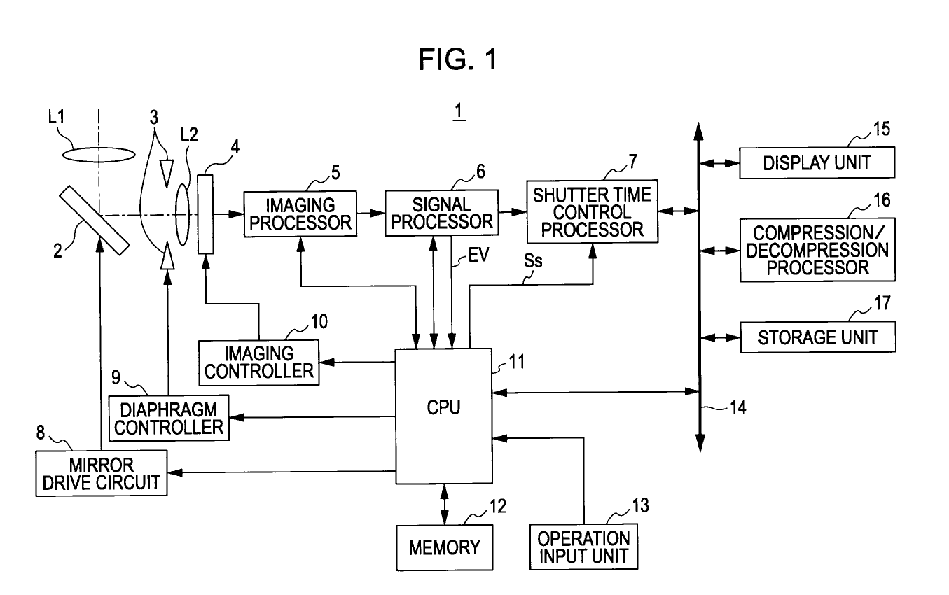

FIG. 1 is a block diagram illustrating the internal configuration of an imaging apparatus 1 in accordance with an embodiment of the present invention. The imaging apparatus 1 herein is configured as a video camera apparatus able to record video footage.

First, the imaging apparatus 1 is provided with imaging optics that include a lens L1, a deformable mirror apparatus 2, a lens L2, and a diaphragm 3.

The lens L1 and the lens L2 schematically represent lens groups in the imaging optics provided in order to resolve subject light (i.e., an image) onto the imaging elements 4 to be hereinafter described. The lens L1 schematically represents a lens group used to lead subject light to the deformable mirror apparatus 2, while the lens L2 schematically represents a lens group used to lead subject light reflected off the mirror surface of the deformable mirror apparatus 2 to the imaging elements 4. It should be appreciated that, in practice, the imaging optics may include a greater number of lenses or other optical elements.

The deformable mirror apparatus 2 includes a flexible member (i.e., the flexible member 32 to be hereinafter described) formed on the front surface thereof, as well as a mirror surface made up of a metal film such as an aluminum film that is formed as a coating on the flexible member 32. The shape of the flexible member 32 changes according to a drive signal issued from the mirror drive circuit 8 shown in FIG. 1, thereby causing the mirror surface to deform to convex or concave curvature. As a result, the focal point position is varied. The configuration and operation of the deformable mirror apparatus 2 will be described later.

The diaphragm 3 is inserted between the deformable mirror apparatus 2 and the lens L2, and is configured to adjust the amount of light that forms an optical image on the imaging elements 4 by varying the passable range of incident light on the basis of control from a diaphragm controller 9 to be hereinafter described.

The imaging elements 4 may be an array of CMOS (Complementary Metal Oxide Semiconductor) sensors, for example. The imaging elements 4 perform photoelectric conversion with respect to subject light resolved via the imaging optics described above. As a result, R (red), G (green), and B (blue) image signals are obtained. The image read control whereby the imaging elements 4 read an image represented by the above image signals is conducted by an imaging controller 10 on the basis of instructions from a CPU (Central Processing Unit) 11 to be hereinafter described.

An imaging processor 5 includes components such as a sample-and-hold/AGC (Automatic Gain Control) circuit and video A/D converter for conducting processing such as gain adjustment and waveform shaping with respect to signals obtained by (i.e., read by) the imaging elements 4. As a result, the imaging processor 5 obtains digital image data. In addition, the imaging processor 5 may also process the image data to correct non-uniform sensor sensitivity or adjust white balance, for example.

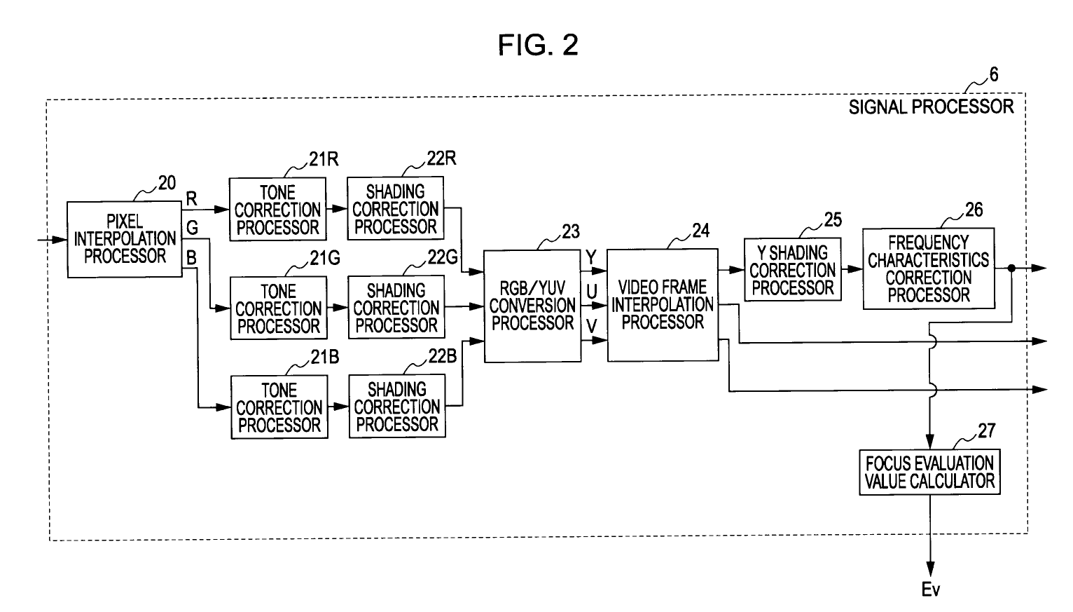

A signal processor 6 performs various image signal processing with respect to the image data (i.e., the R, G, and B image signals) that were obtained via the imaging processor 5. FIG. 2 illustrates the internal configuration of the signal processor 6.

As shown in FIG. 2, the signal processor 6 includes a pixel interpolation processor 20, tone correction processors 21R, 21G, and 21B, shading correction processors 22R, 22G, and 22B, an RGB/YUV conversion processor 23, a video frame interpolation processor 24, a Y shading correction processor 25, a frequency characteristics correction processor 26, and a focus evaluation value calculator 27.

In FIG. 2, the pixel interpolation processor 20 performs pixel interpolation processing with respect to the respective sets of R, G, and B image data obtained via the imaging processor 5. After being subjected to pixel interpolation processing by the pixel interpolation processor 20, the R image data is supplied to the tone correction processor 21R, the G image data is supplied to the tone correction processor 21G, and the B image data is supplied to the tone correction processor 21B.

The tone correction processors 21R, 21G, and 21B respectively perform tone correction processing with respect to supplied image data (such as compressing 12-bit image data to 8-bit image data, for example). After being processed by the tone correction processor 21R, the R image data is supplied to the shading correction processor 22R, while the similarly processed G image data is supplied to the shading correction processor 22G, and the similarly processed B image data is supplied to the shading correction processor 22B.

The shading correction processors 22R, 22G, and 22B respectively process supplied image data to correct non-uniform shading due to the characteristics of the imaging optics and/or the imaging elements 4. Such non-uniform shading may be manifested as a reduction in the amount of light at the outer edges of an image, for example.

On the basis of the R image data, the G image data, and the B image data processed by the above shading correction processors 22R, 22G, and 22B, respectively, the RGB/YUV conversion processor 23 generates image data represented by a Y signal (i.e., a luma signal), image data represented by a U signal (equal to (B−Y)), and image data represented by a V signal (equal to (R−Y)). The image data generated as above is herein referred to as Y image data, U image data, and V image data, respectively. In this case, the sampling ratio of the Y, U, and V data is set such that U and V are sampled at a lower rate than that of Y. For example, a sampling ratio of Y:U:V=4:2:2 may be used.

The video frame interpolation processor 24 performs frame interpolation processing with respect to the Y image data, the U image data, and the V image data obtained by the RGB/YUV conversion processor 23. After being processed by the video frame interpolation processor 24, the U image data and the V image data are respectively supplied to the shutter time control processor 7 shown in FIG. 1. Meanwhile, the Y image data that has been processed by the video frame interpolation processor 24 is subsequently supplied to the Y shading correction processor 25.

The Y shading correction processor 25 performs shading correction processing with respect to Y image data that has been processed by the video frame interpolation processor 24. Subsequently, the frequency characteristics correction processor 26 performs frequency characteristics correction processing with respect to Y image data that has been first processed by the Y shading correction processor 25. For example, the frequency characteristics correction processor 26 may perform high-frequency correction (i.e., edge correction). After being processed by the frequency characteristics correction processor 26, the Y image data is split and supplied to both the shutter time control processor 7 shown in FIG. 1 as well as the focus evaluation value calculator 27 shown in FIG. 2.

The focus evaluation value calculator 27 uses Y image data that has been processed by the frequency characteristics correction processor 26 to calculate a focus evaluation value Ev that acts as an evaluation index for in-focus point search. More specifically, in the present case, the focus evaluation value calculator 27 calculates the magnitude of the high-frequency components of the Y image data, and sets the result as the focus evaluation value Ev. After being calculated by the focus evaluation value calculator 27, the focus evaluation value Ev is supplied to the CPU 11, as shown in FIG. 1.

Returning now to FIG. 1, the shutter time control processor 7 is configured to process the Y, U, and V image data supplied from the signal processor 6 on the basis of a shutter time command signal supplied from the CPU 11. As a result of such signal processing, various effects are realized, such as an improved S/N ratio obtained by varying the shutter time length. The internal configuration of the shutter time control processor 7, as well as the specific signal processing executed thereby, will be described later.

The CPU 11 is provided as a controller that conducts overall control of the imaging apparatus 1. As shown in FIG. 1, memory 12 is also provided for use by the CPU 11. By following a program stored in the memory 12, the CPU 11 executes various computational processing, and additionally exchanges control signals or other information with respective components via the diaphragm controller 9, the imaging controller 10, the mirror drive circuit 8, and a bus 14, thereby causing respective components to execute desired operations.

For example, the CPU 11 may conduct a control to obtain suitable aperture values by instructing the diaphragm controller 9 to drive the diaphragm 3 on the basis of information regarding the amount of light in the image signal as detected by the imaging processor 5.

In addition, the CPU 11 is also configured to conduct an autofocus (AF) control by instructing the mirror drive circuit 8 to control the deformation of the deformable mirror apparatus 2 on the basis of the focus evaluation value Ev that is acquired from the focus evaluation value calculator 27 provided in the signal processor 6, as described above. The AF control will be described later.

An operation input unit 13 includes various user-operable elements such as keys, buttons, and dials used to issue various operating instructions and input information. For example, there may be provided a user-operable element for issuing a power on/off command, or for issuing a command to start/stop the recording of video footage. The operation input unit 13 supplies information obtained from such user-operable elements to the CPU 11. The CPU 11 then conducts suitable computational processing and/or control according to the received information.

A compression/decompression processor 16 compresses or decompresses image data received as input via the bus 14. For example, the compression/decompression processor 16 may perform image compression/decompression processing in accordance with the MPEG (Moving Pictures Experts Group) standard.

A storage unit 17 is used to save image data as well as various other data. The storage unit 17 may include solid-state memory such as flash memory, or another type of memory such as a HDD (Hard Disk Drive), for example.

In addition, instead of a built-in recording medium, the storage unit 17 may also be configured as a recording and playback drive compatible with a portable recording medium such as a memory card housing solid-state memory, an optical disc, a magneto-optical disk, or hologram memory.

Of course, the storage unit 17 may also be provided with both built-in memory such as solid-state memory or a HDD, as well as a recording and playback drive compatible with a portable recording medium.

On the basis of control by the CPU 11, the storage unit 17 records and retrieves image data and various other data received as input from the bus 14.

A display unit 15 is provided with an LCD (Liquid Crystal Display) or similar display panel unit, as well as a display driving unit that drives the display of the display panel unit. The display driving unit is configured as a pixel driving circuit that causes various display data received as input via the bus 14 to be displayed on the display panel unit. The pixel driving circuit respectively applies drive signals derived from an image signal at predetermined horizontal and vertical drive timings to individual pixels disposed in a matrix array in the display panel unit, thereby causing a display to be formed.

Herein, when recording, the CPU 11 conducts a control such that image data that has been processed by the shutter time control processor 7 is supplied to the compression/decompression processor 16, and compressed image data is subsequently generated by the compression/decompression processor 16. Additionally, the storage unit 17 is configured to record the compressed image data that has been generated by the compression/decompression processor 16 on the basis of control by the CPU 11 as above.

In addition, when recording, the CPU 11 conducts a control such that the image data that has been processed by the shutter time control processor 7 is also supplied to the display unit 15, thereby causing video to be displayed in real-time by the display unit 15.

In addition, when a playback command is issued with respect to compressed image data that has been recorded in the storage unit 17, the CPU 11 first controls the storage unit 17 so as to retrieve the specified compressed image data, and then controls the compression/decompression processor 16 so as to decompress the compressed image data that has been retrieved. Subsequently, the CPU 11 conducts a control such that the decompressed image data is displayed by the display unit 15.

### (Configuration of the Deformable Mirror Apparatus)

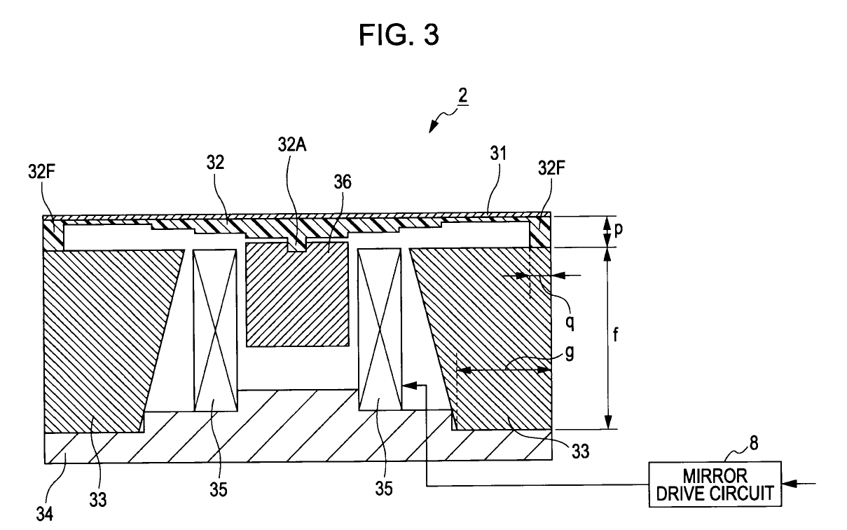

Next, the configuration and operation of the deformable mirror apparatus 2 shown in FIG. 1 will be described with reference to FIGS. 3 to 8.

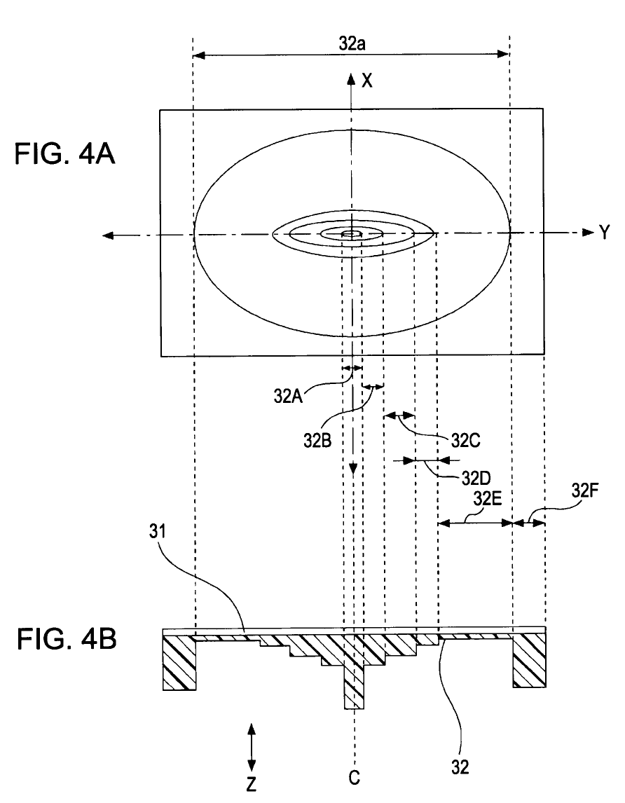

FIGS. 3, 4A, and 4B are diagrams for explaining the configuration of the deformable mirror apparatus 2. FIG. 3 shows a cross-section view of the deformable mirror apparatus 2. FIGS. 4A and 4B illustrate the configuration of the flexible member 32 provided in the deformable mirror apparatus 2. FIG. 4A illustrates the configuration of the flexible member 32 as seen from the surface opposite to the surface upon which the reflective film 31 is formed (i.e., from the back surface upon which is mirror surface is not formed). FIG. 4B illustrates the configuration of the flexible member 32 in cross-section. Furthermore, FIG. 3 illustrates the deformable mirror apparatus 2 together with the mirror drive circuit 8 shown in FIG. 1.

First, as shown in FIG. 3, the deformable mirror apparatus 2 includes: a flexible member 32; a reflective film 31, formed upon the surface of the flexible member 32; a magnet 36, secured to the flexible member 32 on the surface opposite to the mirror surface formed by the reflective film 31; a base substrate 34; a drive coil 35 secured to the base substrate 34, and a reinforcing member 33 provided inserted between the flexible member 32 and the base substrate 34.

The flexible member 32 is flexible and may be fabricated from silicon, for example. The reflective film 31 is attached to the surface of the flexible member 32 that is to act as the mirror surface. In addition, the flexible member 32 in this case includes a plurality of concentric elliptical portions 32A, 32B, 32C, 32D, and 32E formed about a center C on the back surface with respect to the mirror surface. The plurality of elliptical portions 32A to 32E are formed such that the elliptical portion 32A contains the center C and has the greatest thickness, and the elliptical portions 32B, 32C, 32D, and 32E are successively formed around the outer circumference starting from the elliptical portion 32A and successively decreasing in thickness. In other words, the flexible member 32 in the present case is formed such that the cross-sectional shape thereof decreases in thickness in a stepped manner extending radially outward from a center C. Herein, the direction of thickness of the elliptical portions 32A to 32E is defined as the Z axis direction.

In addition, a rib-shaped frame 32F is formed in the region extending along the outer circumference of the region where the elliptical portion 32E is formed. The rib-shaped frame 32F is formed to sufficiently reinforce the outer circumferential region such that the region does not deform when driving force is applied to the flexible member 32 in the Z axis direction as described hereinafter.

In the flexible member 32 herein, the combined area of the elliptical portions 32A to 32E is taken to be equal to the deformable area of the deformable mirror. More specifically, the shape of the mirror surface changes in a predetermined way in response to a driving force (to be hereinafter described) uniformly applied to the central elliptical portion 32A in the Z axis direction, with the change in the shape of the mirror surface being determined according to the pattern formed as a result of the respectively different thicknesses of the elliptical portions 32A to 32E.

By forming a pattern of different cross-sectional thicknesses in this way, a desired strength distribution can be imparted to the flexible member 32. Accordingly, the pattern formed by varying cross-sectional thicknesses in this way is herein referred to as a strength distribution pattern. In the present case, the pattern formed by the elliptical portions 32A to 32E is taken to be the strength distribution pattern 32a.

As described above, a frame 32F is formed around the outer circumference of deformable area defined by the elliptical portions 32A to 32E, the frame 32F being of sufficient strength to maintain its shape when a driving force as described above is applied thereto. By providing such a frame 32F as the outermost circumferential portion of the flexible member 32, the outermost circumferential portion becomes strong enough to maintain its shape even when a driving force is applied thereto. As a result, it becomes easier to cause the deformable portion of the flexible member 32 (i.e., the elliptical portions 32A to 32E) to deform in response to a driving force in a way that more closely matches an ideal deformation. In other words, the above enables high-precision deformation of the flexible member 32 in response to a driving force that more closely resembles the ideal deformation, as compared to the case wherein the outermost circumferential portion of the flexible member 32 also deforms.

In the present case, the strength distribution pattern 32a is formed by means of elliptical shapes because a mirror surface angled at 450 is used as part of the deformable mirror apparatus 2, as shown in FIG. 1.

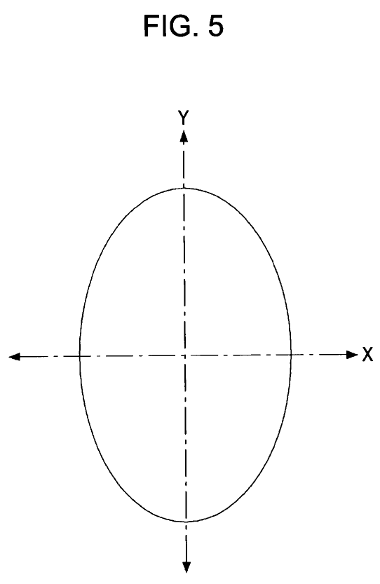

In this case, the spot shape of light incident on the mirror surface becomes an elliptical shape, as illustrated in FIG. 5. More specifically, the spot shape becomes an elliptical shape having a ratio of diameters in the X axis direction and the Y axis direction that is approximately X:Y=1:√2, wherein the major axis of the spot is taken to be the Y axis direction, and the minor axis orthogonal to the major axis is taken to be the X axis direction.

When the spot shape of light incident on the mirror surface forms an ellipse as described above, focus control can be favorably conducted. For this reason, an elliptical shape is also used for the strength distribution pattern 32a.

In addition, as described earlier, the strength distribution pattern 32a is positioned such that the elliptical portions are concentric about a center C. In so doing, when a driving force is applied to the flexible member 32, concentration of stress at a single portion is prevented, thereby effectively preventing breakage or fatigue fracture of the flexible member 32.

Herein, when a given driving force is applied in order to deform the mirror surface, internal stress is generated in the flexible member 32. At this point, if there existed a hypothetical portion in the flexible member 32 where the stress is concentrated at a single point, and furthermore if the flexible member 32 were fabricated from a homogenous and isotropic material like that of the present example, then the dimensions of the stressed portion would suddenly and radically change.

For example, for a pattern wherein respective elliptical portions are not concentric, the spacing between elliptical portions becomes wider and narrower in specific directions. The portions with narrower spacing experience more concentrated stress compared to other portions, and thus the dimensions of such portions change suddenly and radically in response to the application of a uniform driving force.

If such portions of concentrated stress exist, then there is an increased possibility that the allowable stress for the flexible member 32 will be exceeded at such portions, in turn leading to an increased possibility of breakage. Moreover, there is concern that repeated deformations of the flexible member will lead to fatigue fracture at such portions.

By patterning the flexible member 32 such that the elliptical portions are concentric as in the present example, the pattern spacing becomes equal, and the concentration of stress at individual portions as described above does not occur. In other words, breakage and fatigue fractures of the flexible member 32 can be prevented as a result.

Returning now to FIG. 3, secured to the elliptical portion 32A formed in the central portion of the flexible member 32 is a cylindrical magnet 36. The magnet 36 includes a centrally-formed depressed portion into which the elliptical portion 32A may be fitted. When the elliptical portion 32A is fitted into the depressed portion, the elliptical portion 32A is firmly secured by adhesion or other means.

In addition, the frame 32F formed along the outermost circumferential portion of the flexible member 32 is secured to a reinforcing member 33, as shown in FIG. 3.

Pyrex® glass, for example, may be selected as the material constituting the reinforcing member 33. More specifically, a material stronger than that of the flexible member 32 is preferably selected. The outer shape of the reinforcing member 33 is that of a quadrangular prism having a tapered hole passing centrally therethrough. The outer dimensions of the two surfaces of the reinforcing member 33 having hollowed-out portions due to the tapered hole match the outer circumferential dimensions of the surface formed by the mirror surface of the flexible member 32. In addition, the frame 32F of the flexible member 32 is secured to one of the surfaces of the reinforcing member 33. In the present case, the flexible member 32 and the reinforcing member 33 are positioned and secured in a coaxial configuration with respect to the respective central axes thereof. In so doing, the frame 32F is secured to the portions of the reinforcing member 33 surrounding the hole.

The base substrate 34 has a surface with external dimensions identical to those of the surface formed by the mirror surface of the flexible member 32. In addition, the outermost circumferential portion of the surface with identical dimensions has formed thereon a cutaway portion for securely positioning the surface of the reinforcing member 33 that is opposite to the surface secured to the flexible member 32. More specifically, a circular protruding portion is formed having a diameter approximately equal to the inner diameter of the tapered hole at the surface of the reinforcing member 33 that is opposite to the surface secured to the flexible member 32. Furthermore, the base substrate 34 and the reinforcing member 33 are coaxially positioned, with the reinforcing member 33 being securely positioned in the cutaway portion formed as a result of the above protruding portion.

Furthermore, a circular protruding portion for positioning is centrally formed on the base substrate 34 and fits as a joint with the inner wall of a drive coil 35. More specifically, the protruding portion is formed coaxially centered on the base substrate 34, with its outer diameter set to a size that fits as a joint with the inner wall of the drive coil 35. Since the drive coil 35 is thus jointed and secured to the base substrate 34 as a result of the protruding portion, the outer surface of the magnet 36 and the inner surface of the drive coil 35 become uniformly spaced apart across the entire circumference thereof. Moreover, the magnet 36 and the drive coil 35 become coaxially positioned.

In addition, as shown in FIG. 3, a drive signal supply line from the mirror drive circuit 8 is connected to the drive coil 35.

In the case of the present embodiment, the vertical thickness (i.e., the height) p of the frame 32F of the flexible member 32 is set to the same value as the vertical thickness of the elliptical portion 32A formed at the center of the flexible member 32, as shown in FIG. 3.

In addition, the height f of the reinforcing member 33 is set to be greater than the height p of the frame 32F of the flexible member 32.

Furthermore, in the horizontal direction, the width q of the frame 32F and the width g of the reinforcing member 33 are set at least such that q is less than g. (Since the hole in the reinforcing member 33 is tapered in the present case, the width g herein is taken to be the value of the smaller width).

Herein, the vertical direction refers to the direction orthogonal to the mirror surface, while the horizontal direction, being orthogonal to the vertical direction, refers to the direction parallel to the mirror surface.

Needless to say, the dimensions of the tapered hole formed in the reinforcing member 33 are preferably set such that an amount of space is reserved allowing the drive coil 35 in advance. In addition, since predetermined deformations of the mirror surface are not acquired if the flexible member 32 and the drive coil 35 interfere with each other when the flexible member 32 deforms, the vertical thickness f of the reinforcing member 33 is preferably set such that sufficient clearance is reserved between the drive coil 35 and the flexible member 32.

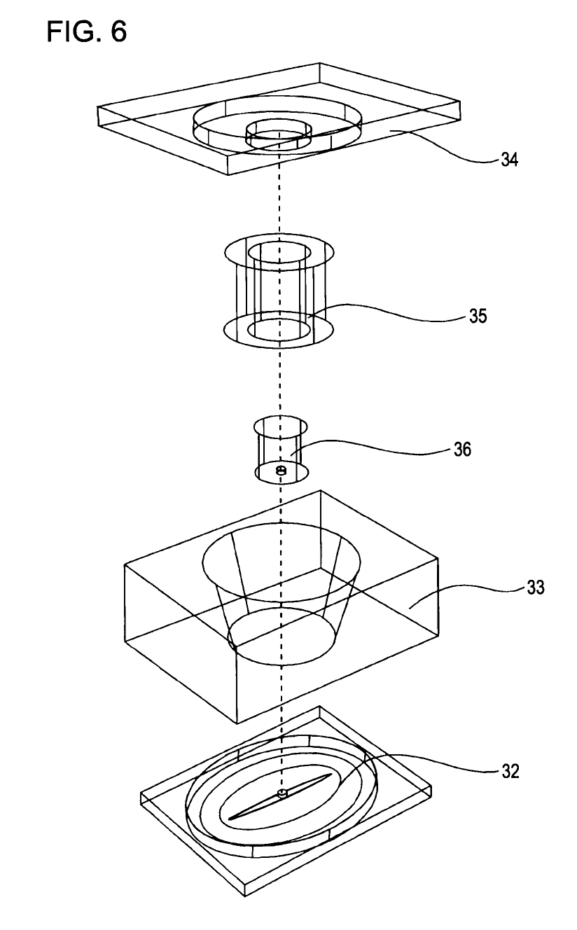

An exemplary method for manufacturing a deformable mirror apparatus 2 like the above will now be described with reference to FIG. 6. FIG. 6 is an exploded perspective view of a deformable mirror apparatus 2.

First, a material such as silicon is selected for the flexible member 32 as described above. The elliptical portions 32A to 32E and the frame 32F are then imparted to planar silicon of thickness p, as shown in cross-section in FIG. 4B. The above may be performed by means of etching using a semiconductor fabrication process, for example.

In the present embodiment as described above, the thicknesses of the frame 32F and the elliptical portion 32A of the flexible member 32 are set to the same value p. However, when the thicknesses of the frame 32F and the elliptical portion 32A are set to the same value in this way, the thickness of the pre-processed silicon may also be set to at least the same thickness of the frame 32F and the elliptical portion 32A. The above is possible because the frame 32F extending along the outermost circumferential portion is the thickest portion of the flexible member 32 in terms of cross-sectional thickness, as described earlier. Furthermore, if the thicknesses of the frame 32F and the elliptical portion 32A are set to the same value p in this way, the region to be etched becomes limited to just the area containing the elliptical portions 32B to 32E.

After having fabricated the flexible member 32 by means of etching as described above, a reflective film 31 of aluminum or similar material is applied as a film using a sputtering or similar method to the surface of the flexible member 32 opposite to the surface imparted with the cross-sectional shape of the strength distribution pattern 32a. The mirror surface is formed as a result. Subsequently, as described above, the magnet 36 is firmly secured by adhesion or similar means to the centrally-positioned elliptical portion 32A.

Next, the reinforcing member 33 is coaxially positioned with and secured to the flexible member 32 on the surface of the flexible member 32 opposite to the mirror surface. In the present case, the securing of the silicon-based flexible member 32 to the Pyrex glass-based reinforcing member 33 is conducted by means of anodic bonding.

Herein, the joining of the materials constituting the flexible member 32 and the reinforcing member 33 may also be conducted while taking into account the respective coefficients of linear expansion for each material.

For example, in the case of anodic bonding, the materials are heated when bonding. However, if materials having entirely different coefficients of linear expansion are bonded together, then the flexible member 32 may become misshapen due to the difference in the contraction percentages of the respective materials upon returning to room temperature after bonding. In other words, the above may lead to worsened flatness characteristics of the mirror surface. Taking the above into account, in the present example a combination of a silicon material and a Pyrex glass with relatively similar coefficients of linear expansion is used.

Alternatively, the problem related to the coefficients of linear expansion can be avoided by using the same material for both the flexible member 32 and the reinforcing member 33. More specifically, both the flexible member 32 and the reinforcing member 33 may be fabricated from silicon. When silicon is used as the material for both the flexible member 32 and the reinforcing member 33, surface activated bonding at room temperature may be conducted.

Next, as shown in FIG. 6, the base substrate 34 is fabricated by etching or otherwise processing a planar member to form a cutaway portion along the outermost circumferential portion thereof as well as a centrally-positioned protruding portion, as described above. As can be understood from the foregoing description, the outer dimensions of the surface whereupon the cutaway portion and the protruding portion are formed are identical to the outer dimensions of the mirror surface of the flexible member 32.

Subsequently, the drive coil 35 is positioned and secured by adhesion to the base substrate 34 by means of the centrally-positioned protruding portion. Subsequently, the reinforcing member 33 is positioned and secured to base substrate 34 by means of the cutaway portion formed along the outermost circumferential portion of the base substrate 34. By securing the respective components in this way, the deformable mirror apparatus 2 shown in FIG. 3 is formed.

At this point, a drive signal is supplied from the mirror drive circuit 8 to the drive coil 35 provided in the deformable mirror apparatus 2 having the configuration described above. When a drive signal is supplied in this way and current passes through the drive coil 35, a magnetic field is generated in accordance with the level of current. As a result of the magnetic field thus generated, the magnet 36 disposed inside the drive coil 35 receives a repulsive force. In the present case, the magnet 36 has been magnetized along the axis of the cylinder, and thus the repulsive force is generated in the Z axis direction. In other words, as a result of the above, a uniform driving force is applied in the Z axis direction in accordance with the level of the drive signal, with the driving force ultimately acting upon the central portion of the flexible member 32 that is secured to the magnet 36.

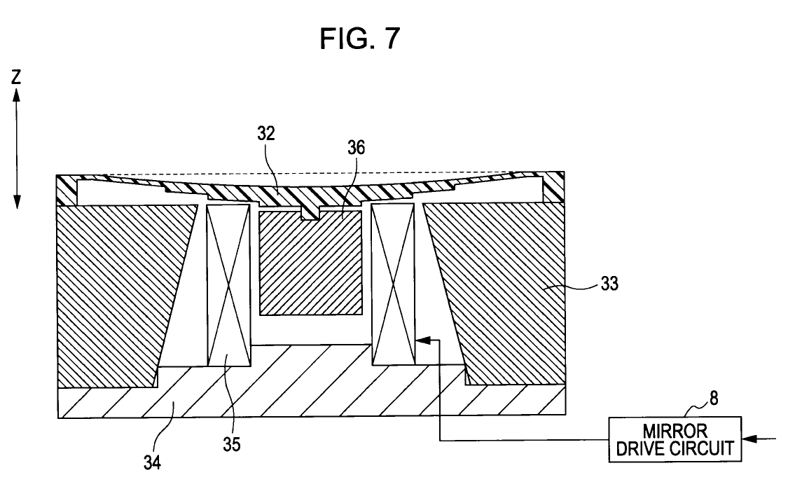

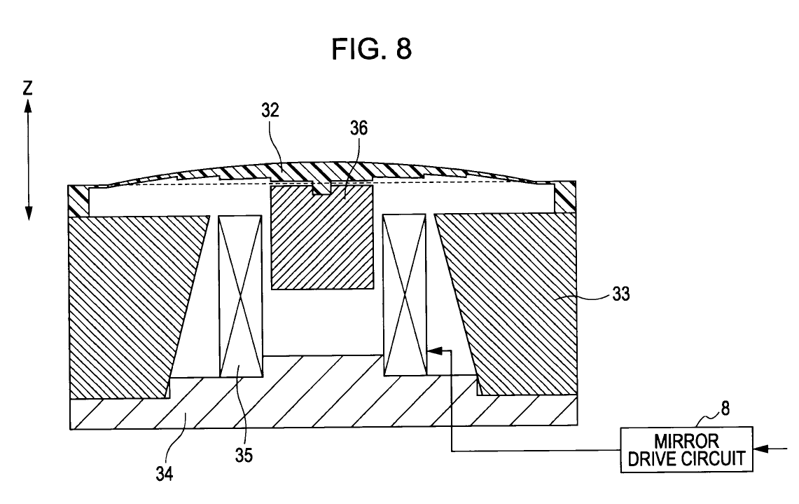

FIGS. 7 and 8 show cross-section views of a deformable mirror apparatus 2 whose mirror surface has deformed due to a supplied drive signal as described above. For convenience, illustration of the reflective film 31 has been omitted from FIGS. 7 and 8. In addition, for comparison, the broken line illustrated in FIGS. 7 and 8 indicates the position of the mirror surface in the non-deformed state as shown in FIG. 3.

FIGS. 7 and 8 illustrate the deformation of the mirror surface to convex and concave curvature, respectively. The change to convex and concave curvature as shown in FIGS. 7 and 8 is obtained by altering the polarity of drive signal supplied to the drive coil 35.

It should be appreciated that if focus control is conducted using a deformable mirror apparatus 2 as described above, then modifying the driving force applied to the flexible member 32 (i.e., the drive signal level or drive signal value imparted to the drive coil 35) also involves adjustment in accordance with a target focal point for a respective drive state. In other words, the driving force is adjusted so as to obtain a target deformation for a respective drive state.

In the case of a deformable mirror apparatus 2 configured as described above, the manner in which the mirror surface changes for each drive state (i.e., how the mirror surface changes in response to respective changes in the Z axis direction of the elliptical portion 32A provided in the center of the flexible member 32) is determined by the configuration of the strength distribution pattern 32a. The indexing of various configurations of the strength distribution pattern 32a in order to adjust the driving force in accordance with target focal points for respective drive states may be conducted using an FEM (Finite Element Method) simulation tool, for example.

Furthermore, the deformable mirror apparatus 2 of the present embodiment as described above is configured such that the reinforcing member 33 is inserted between the base substrate 34 and the flexible member 32, thereby causing the flexible member 32 to be supported by the reinforcing member 33 on the side facing the base substrate 34, as shown in FIG. 3. In so doing, forces resulting from stresses induced within the deformable mirror apparatus 2 (such as the stresses induced when mounting the deformable mirror apparatus 2 in the imaging apparatus 1) are effectively suppressed and prevented from affecting the flexible member 32. As a result, worsening of the flatness characteristics of the mirror surface that can occur when mounting the deformable mirror apparatus 2 is suppressed.

Suppressing the worsening of flatness characteristics in this way allows the deformation precision of the mirror surface to be improved, and likewise allows focal point adjustment precision to be improved to an equivalent degree.

In the above case, the present embodiment is configured such that the width g of the reinforcing member 33 is at least set to be greater than the width q of the frame 32F of the flexible member 32. For example, if the materials constituting the flexible member 32 and the reinforcing member 33 are of equal strength (i.e., bending strength), then configuring the widths as described above ensures that the deformable mirror apparatus 2 can more reliably withstand the stresses induced during mounting as compared to a deformable mirror like that disclosed in JP-A-2004-170637, wherein a reinforcing member 33 is not provided. As a result, it becomes possible to reliably suppress worsening of the flatness characteristics of the mirror surface.

The present embodiment is configured such that strength reinforcement functions are assumed by a separately-provided reinforcing member 33 rather than by the flexible member 32 itself. Doing so enables strength reinforcement to be provided while effectively keeping the apparatus size small. Hypothetically, if strength reinforcement were provided by increasing the width q of the frame 32F of the flexible member 32 without providing the reinforcing member 33, then the horizontal cross-sectional thickness of the frame 32F would likely be extended radially outward, in order to maintain the space wherein a strength distribution pattern 32a is formed when obtaining a predetermined deformation of the mirror surface (i.e., in order to maintain the deformable area of the elliptical portions 32A to 32E). In contrast, when the reinforcing member 33 is provided, it becomes possible to provide strength reinforcement by configuring a reinforcing member 33 whose horizontal cross-sectional thickness extends radially inward past the frame 32F. As a result, strength reinforcement is provided while also keeping the apparatus size small.

In addition, by configuring the deformable mirror apparatus 2 such that strength reinforcement functions are assumed by a separately-provided reinforcing member 33, the vertical thickness (i.e., the height p) of the frame 32F of the flexible member 32 can be reduced. In so doing, the etching depth becomes correspondingly shallower when etching to form the frame 32F and the strength distribution pattern 32a of the flexible member 32. Moreover, etching time can also be reduced, thereby allowing for improved manufacturing efficiency and reduced manufacturing costs.

In addition, by making the etching depth shallower in this way, it becomes possible to correspondingly improve the dimensional precision of the stepped shape of the strength distribution pattern 32a, and by extension improve the focal point adjustment precision.

There exist other techniques for reinforcing the deformable mirror apparatus 2 to withstand the stresses occurring when mounting the apparatus. For example, a frame portion having a predetermined cross-sectional thickness may be integrally formed along the outer circumferential portion of the base substrate 34. However, when a reinforcing frame portion is integrally formed on the base substrate 34, stresses generated at the floor of the base substrate 34 easily propagate to the frame portion, leading to concerns that the flexible member 32 may easily deform.

Furthermore, when a reinforcing frame portion is integrally formed on the base substrate 34 in this way, then the base substrate 34 is first formed having a depressed cross-sectional shape. However, as described earlier, a protruding portion is also formed on the floor of the base substrate 34 in order to position and secure the drive coil 35. In other words, in this case the circumferential frame portion becomes an obstacle when shaping the protruding portion, thus leading to concerns of increased shaping difficulty and decreased manufacturing efficiency, as well as an accompanying increase in manufacturing costs.

In contrast, in the present embodiment, the reinforcing member 33 is separately provided, thereby allowing the protruding portion for positioning the coil on the base substrate 34 to be formed with an extremely simple process. As a result, manufacturing costs can be correspondingly reduced. Furthermore, the fabrication of the reinforcing member 33 is also formed with an extremely simple process, being at its simplest the formation of a hole of predetermined diameter in a base material.

In addition, in the deformable mirror apparatus 2 of the present embodiment, the magnet 36 is secured on the side nearest the flexible member 32 (i.e., the movable side), while the drive coil 35 is secured on the side nearest the base substrate 34 (i.e., the stationary side), resulting in a moving magnet configuration. Implementing such a configuration allows for improved focal point adjustment precision.

Consider, for example, a configuration wherein a coil is secured on the movable side (i.e., the side nearest the flexible member 32), and consequently a wiring cable for supplying power to the coil is also connected to the movable side. As a result of such a configuration, there is concern that pressure may be imparted to the flexible member as a result of stresses due to the bending of the power supply cable. By extension, there is also concern that the mirror surface may deform and experience impaired flatness characteristics.

In contrast, by implementing a moving magnet configuration as in the present embodiment, pressure due to the power supply cable is not imparted to the movable side, and thus the flatness of the mirror surface is more reliably achieved. Furthermore, if the flatness of the mirror surface is achieved in this way in the initial (i.e., non-deformed) state, then the above allows for correspondingly improved focal point adjustment precision.

In addition, by implementing a moving magnet configuration as described above wherein the drive coil 35 is secured on the side nearest the base substrate 34, heat generated by the drive coil 35 is able to escape from the side nearest the base substrate 34. More specifically, by selecting a material having a relatively high thermal conductivity for the base substrate 34 in this case, internal temperature increases inside the deformable mirror apparatus 2 can be effectively suppressed.

In addition, according to the configuration of the deformable mirror apparatus 2 of the present embodiment, it is possible to manufacture the deformable mirror apparatus 2 using semiconductor fabrication processes such as film deposition, etching, and bonding, as was described with reference to FIG. 6. For this reason, high-precision mass production becomes relatively simple. Furthermore, since it is possible to utilize semiconductor fabrication processes, the deformable mirror apparatus 2 can be miniaturized, and manufacturing costs can be kept relatively low.

### (Focus Control Technique of the First Embodiment)

As described earlier, if a hill climbing technique used for in-focus point search is adopted as the autofocus technique while recording video footage, a problem occurs in that defocused footage resulting from the in-focus point search process is also recorded. In the present embodiment, a technique for resolving this problem is proposed. In the technique of the present embodiment, the reading of image data is conducted in two periods. In addition to an image reading period for recording footage, another image reading period is inserted in order to obtain a focus evaluation value Ev used for in-focus point search.

Obviously, the focal position is preferably aligned to an in-focus point during the period wherein image data is read in order to record footage. Meanwhile, during the period wherein image data is read in order to find an in-focus point, a focal position is set according to the parameters of the in-focus point search. It can thus be seen that by implementing a technique as described above wherein the reading of image data is differentiated, the state of focal point adjustment is switched for the respective image reading periods.

At this point, if it assumed that adjustment of focal position is conducted by driving a focus lens using a motor as in the related art, then a large amount of time may be involved in switching from an in-focus position to a focal position set for in-focus point search. As a result, it becomes highly difficult to instantly switch the focal position in accordance with the switching between the image reading periods.

However, if a deformable mirror apparatus 2 as described above is used, then focal position adjustment can be conducted by inducing slight changes in the cross-sectional shape of the mirror surface (i.e., the flexible member 32), and thus focal position adjustment can be conducted very rapidly. More specifically, the focal position can be switched at sufficient speed to match the switching between the image reading periods. In the present embodiment, by utilizing the fast response characteristics of such a deformable mirror apparatus 2, the above technique of differentiated image reading is realized.

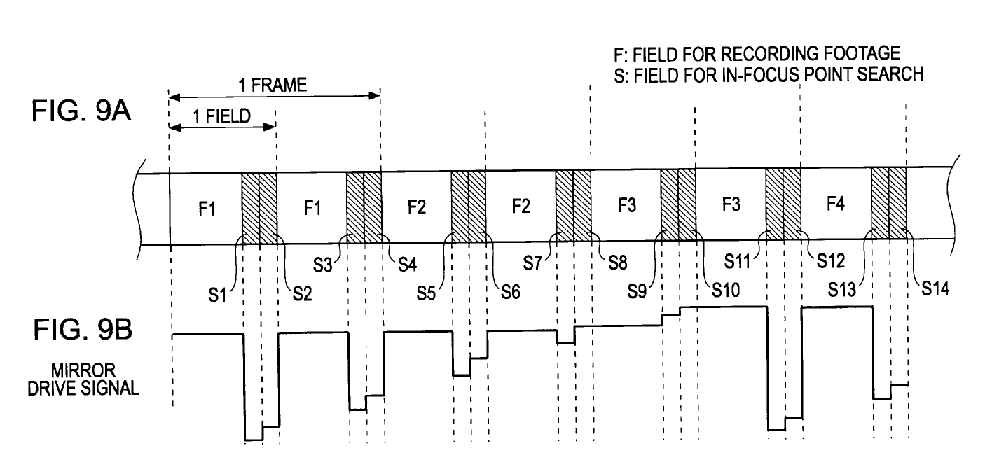

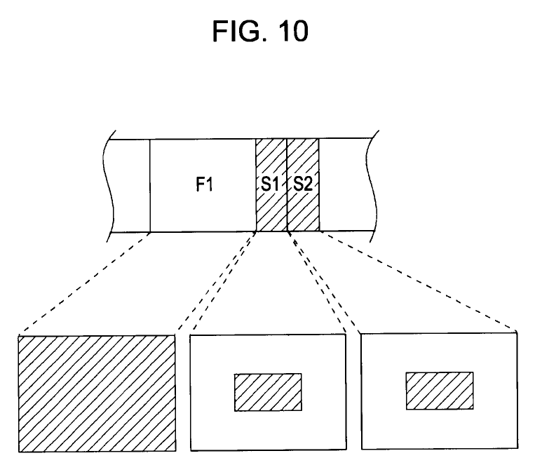

Hereinafter, a focus control technique in accordance with the first embodiment will be described with reference to FIGS. 9A, 9B, and 10. FIGS. 9A and 9B are diagrams for explaining a focal control technique in accordance with the first embodiment. FIG. 9A illustrates the allocation of the image reading periods of the imaging elements, while FIG. 9B illustrates mirror drive signal waveforms. It should be appreciated that the case illustrated in FIGS. 9A and 9B, wherein image reading is presumed to be conducted in an interlaced manner, is given by way of example.

In FIG. 9A, the period labeled “1 FIELD” represents a single, predefined field period. The period labeled “1 FRAME” represents a single, predefined frame period, with two field periods constituting a single frame period.

As shown in FIG. 9A, in the present embodiment, a single, predetermined field period includes a field for recording footage, wherein a field image to be recorded is read (i.e., the first image reading period, labeled F in FIG. 9A), and a field for in-focus point search, wherein an image is read in order to obtain a focus evaluation value Ev for in-focus point search (i.e., the second image reading period, labeled S in FIG. 9A).

In the present case, there exist two fields for in-focus point search during a single field period. More specifically, when viewed along a time axis, there exists a field for recording footage followed by two fields for in-focus point search in succession, with fields for recording footage and fields for in-focus point search being repeated thereafter in the same sequence.

In the present embodiment, the duration of the field for recording footage and the duration of the field for in-focus point search are respectively set to fixed values. More specifically, in the present example, the duration of a field for recording footage is fixed at 10 ms and the duration of a field for in-focus point search is fixed at 3.3 ms, in order to accommodate a frame frequency of 30 Hz. In other words, a single field period is fixed at (10 ms+3.3 ms×2)=16.6 ms.

In addition to allocating image reading periods as described above, the present embodiment is configured to obtain respectively different focus drive states for the respective image reading periods, as shown in FIG. 9B. More specifically, the CPU 11 controls the drive state of the deformable mirror apparatus 2 such that, in the field for in-focus point search, the deformable mirror apparatus 2 is adjusted to a focal point set for use in finding an in-focus point using a hill climbing method. The CPU 11 also controls the deformable mirror apparatus 2 such that, in the field for recording footage, the deformable mirror apparatus 2 is adjusted to an in-focus point that has been found by search.

In the present embodiment, the field for in-focus point search involves a partial reading of the imaging elements 4. FIG. 10 illustrates the read area of the imaging elements 4 in single field periods. As shown in FIG. 10, in the field for recording footage, an interlaced image is read over the entire effective pixel range of the imaging elements 4. In the field for in-focus point search, all pixels are read in a partial area that includes the center of the imaging elements 4. In the present case, the partial area read in the field for in-focus point search may be set according to the field of view whereby a focus evaluation value Ev can be calculated.

By conducting a partial reading as above, it is possible to reduce the quantity of transferred image information, and the processing load involved in calculating the focus evaluation value Ev can be decreased. In so doing, it becomes possible to reduce the amount of consumed power.

Control of the partial reading operation conducted by the imaging elements 4 as described above is realized as a result of the CPU 11 issuing instructions to the diaphragm controller 9.

Finding an in-focus point using a hill climbing technique is conducted as a result of the CPU 11 obtaining focus evaluation values Ev successively calculated by the focus evaluation value calculator 27. Although there exist a variety of specific hill climbing techniques for finding an in-focus point, essentially any technique similar to the following example may be implemented.

First, the focal position is set to infinity (i.e., to Sn), and a focus evaluation value Ev calculated in that state is obtained. Subsequently, the focal position is set to a nearer focal position (herein, Sn+1) separated from the infinity position Sn by a predetermined distance t. A focus evaluation value Ev calculated in the new state is then obtained. In this way, two focus evaluation values Ev for respective focal points spaced apart by the distance t are obtained, and then a determination is made as to which state yielded a more favorable focus evaluation value Ev. If the focus evaluation value Ev for the infinity position Sn is higher, then the infinity position Sn is taken to be the in-focus point. In contrast, if the focus evaluation value Ev for the focal length Sn+1 is higher, then it can be determined that the in-focus point has a focal length of Sn+1 or greater. Consequently, in the latter case, a focus evaluation value Ev is obtained for a focal length (Sn+2) nearer by an additional increment of the distance t, and a determination is made as to whether the focus evaluation value Ev for the focal length Sn+1 or the focal length Sn+2 is more favorable. If the focus evaluation value Ev for the focal length Sn+1 is higher, then the focal length Sn+1 is taken to be the in-focus point. If the focus evaluation value Ev for the focal length Sn+2 is higher, then it can be determined that the in-focus point has a focal length of Sn+2 or greater. Consequently, in the latter case, a focus evaluation value Ev is obtained for a focal length (Sn+3) nearer by an additional increment of the distance t, and a determination is made as to whether the focus evaluation value Ev for the focal length Sn+2 or the focal length Sn+3 is more favorable.

Thereinafter, if the focus evaluation value Ev is more favorable for the focal length nearer by the distance t, then that focus evaluation value Ev is compared to another focus evaluation value Ev obtained by adjusting the focal length closer by another increment of the distance t. When the focus evaluation value Ev for the newly-adjusted focal point becomes lower than that of the immediately previous focal point, the immediately previous focal point is taken to be the in-focus point.

As described above, in the present embodiment, image reading is differentiated by configuring focus drive states that are respectively different for respective image reading periods. Images are read in an in-focus state from the fields for recording footage and recorded, while images read in a focus drive state for in-focus point search are only used to find an in-focus point and are not recorded.

More specifically, the CPU 11 conducts a control with respect to image data obtained on the basis of an image signal read from a field for recording footage, wherein the image data is successively processed by the imaging processor 5, the signal processor 6, and the shutter time control processor 7 (to be hereinafter described), subsequently compressed by the compression/decompression processor 16, and then recorded in the storage unit 17. In addition, the CPU 11 also conducts a control with respect to image data obtained on the basis of an image signal read from a field for in-focus point search, wherein the image data is input into the focus evaluation value calculator 27 from the frequency characteristics correction processor 26 provided in the signal processor 6, thereby causing a focus evaluation value Ev to be calculated for only the image data obtained from the field for in-focus point search. In this way, it becomes possible to prevent recording defocused footage occurring because the focal point is being varied as part of the in-focus point search process.

While recording footage, a real-time display of video footage is shown on the display unit 15. The CPU 11 causes the real-time display of video footage to be executed by causing the display unit 15 to be supplied with image data obtained on the basis of an image signal read from the fields for recording footage, the image data having been first processed by the imaging processor 5, the signal processor 6, and the shutter time control processor 7 in succession. In so doing, defocused footage due to in-focus point search is also prevented from appearing on the real-time display screen.

In addition, the present embodiment is configured such that, when conducting the focus control, the surface shape of the mirror inserted into the imaging optics as the deformable mirror apparatus 2 is deformed in order to adjust the focal point. It should be appreciated that such a configuration allows for a reduction in power consumption over that of a configuration of the related art, wherein a focus lens is driven using a motor. In other words, in the present embodiment, the amount of power consumed to adjust the focal point is merely the minute amount of power used to slightly deform the mirror surface, thereby allowing for a reduction in power consumption over that of a configuration in accordance with the related art.

In addition, configuring the present embodiment with the deformable mirror apparatus 2 allows for increased autofocus speed compared to that of the related art. More specifically, as a result of the deformable mirror apparatus 2, the amount of drive involved in modifying the focal lengths by an equal amount is markedly less in the present embodiment compared to the case where the technique of the related art is implemented to drive a focus lens using a motor. For this reason, it becomes possible to increase response time by an equivalent amount, thereby allowing for increased autofocus speed as a result.

In addition, configuring the present embodiment with the deformable mirror apparatus 2 resolves the problem of motor noise being recorded.

### (Pseudo-Shutter Time Control)

As described above, in the present embodiment, the duration of the field for recording footage is set to a fixed value. Consequently, while in the related art it was possible to electrically control the shutter time (i.e., the shutter speed) by controlling the image read time of the imaging elements 4 to adjust the exposure time, the above technique is impractical in the present example.

When control of the shutter time is feasible, it is possible to increase the shutter time when recording in dark locations and insufficient light is available, for example. Implementing such a technique compensates for a worsened S/N ratio. In other words, control of the shutter time provides noise reduction effects. However, in the present embodiment, the shutter time is fixed as described earlier, and thus the above noise reduction effects are no longer obtained.

However, as described earlier, in the present embodiment a single field period includes a field for in-focus point search, and the duration of the field for recording footage is set to be shorter than a single field period of the related art. As a result, the shutter time becomes a fixed, short value.

When the shutter time is short, the subject is clearly captured in each frame image, and when viewed as video, the motion of the subject appears jerky, particularly during portions wherein the subject is moving quickly. Thus, in the present embodiment as described above wherein the shutter time is set to a fixed value that is shorter than the typical values, the dynamic resolution becomes high, and there is a tendency for the motion of the subject to appear jerky.

Consequently, the present embodiment is configured to conduct a pseudo-shutter time control that reproduces equivalent effects by means of signal processing. In so doing, noise reduction effects are obtained even when the shutter time is fixed, and additionally, it becomes possible to ameliorate the tendency for the motion of the subject to appear jerky as described above. The shutter time control processor 7 shown in FIG. 1 is provided as the signal processor for conducting the pseudo-shutter time control.

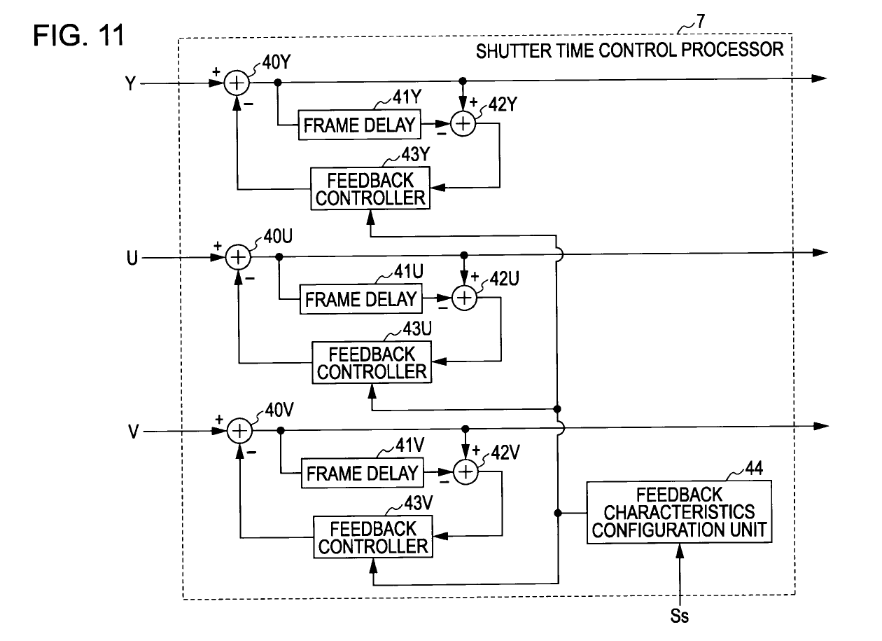

FIG. 11 illustrates the internal configuration of the shutter time control processor 7 shown in FIG. 1. As described with reference to FIG. 1, the shutter time control processor 7 is first supplied with separate Y image data, U image data, and V image data from the signal processor 6. The shutter time control processor 7 is provided with three processing subsystems that perform similar processing on the Y image data, the U image data, and the V image data, respectively. More specifically, a subtractor 40Y, a frame delay circuit 41Y, a subtractor 42Y, and a feedback controller 43Y are provided for processing Y image data. In addition, a subtractor 40U, a frame delay circuit 41U, a subtractor 42U, and a feedback controller 43U are provided for processing U image data, and a subtractor 40V, a frame delay circuit 41V, a subtractor 42V, and a feedback controller 43V are provided for processing V image data.

Since the processing respectively conducted by an individual subtractor 40, a frame delay circuit 41, a subtractor 42, and a feedback controller 43 is identical for each processing subsystem for Y image data, U image data, and V image data, respectively, the following will describe only the processing subsystem for Y image data as a representative example.

As shown in FIG. 11, Y image data is output from the shutter time control processor 7 via the subtractor 40Y, while also being split and respectively supplied to the frame delay circuit 41Y and the subtractor 42Y. The frame delay circuit 41Y applies a delay equivalent to one image to the Y image data supplied from the subtractor 40Y, and then outputs the delayed Y image data to the subtractor 42Y.

The subtractor 42Y then subtracts the Y image data that was delayed by the frame delay circuit 41Y from the Y image data supplied from the subtractor 40Y, thereby obtaining a difference signal expressing the difference between the current Y image data and the Y image data for the immediately previous image.

The feedback controller 43Y receives as input the difference signal obtained as above and applies thereto a coefficient found on the basis of the difference signal values as well as feedback characteristics set by a feedback characteristics configuration unit 44 to be hereinafter described. The feedback controller 43Y then outputs the result to the subtractor 40Y.

The subtractor 40Y then subtracts, from the Y image data received as input from the signal processor 6, the difference signal to which a coefficient was applied by the feedback controller 43 as above.

Herein, the technique of subtracting from the current frame image a difference signal between the current frame image and the immediately previous frame image is referred to as frame noise reduction, and is an established technique for improving the S/N ratio. Herein, if the quantity of feedback from the difference signal is increased, then noise reduction effects can be increased to an equivalent degree.

To describe the above more fully, the difference signal for a given frame image can be used as an index expressing the amount of noise. More specifically, if the value of the difference signal between the current frame and the immediately previous frame is large, then the subject is being clearly captured in each frame, and thus the amount of noise occurring in the given frame is small to the degree that the value of the difference signal is large. In contrast, if the value of the difference signal is small, then the amount is noise is large.

In consideration of the above, in order to obtain a suitable amount of noise reduction corresponding to the amount of noise actually occurring in an image, it is preferable to execute processing such that the coefficient applied to the difference signal that provides feedback (i.e., the amount of feedback) increases when the value of the difference signal is small, and decreases (and thus suppresses the amount of feedback) when the value of the difference signal is large.

In the configuration described earlier, the difference signal is not simply subtracted from the current frame image data, but is instead subtracted after applying a coefficient to the difference signal whose value depends on the value of difference signal itself. Doing so enables control of the amount of noise reduction using arbitrary characteristics.

Furthermore, by subtracting an inter-frame difference signal as described above in order to provide feedback, it is possible to improve the S/N ratio, while also lowering the dynamic resolution. Thus, as can be understood from the above, by implementing a configuration wherein an inter-frame difference signal as above is subtracted to provide feedback, the amount of feedback from the difference signal can be increased, and advantages can be obtained that are equivalent to those of the case wherein the shutter time is increased.

As described above, when the value of the difference signal is large, it can be inferred that the subject is being clearly captured in each frame. Thus it can be understood that the value of the difference signal can also be utilized as an index of dynamic resolution. More specifically, if the value of the difference signal is large, then it can be inferred that the dynamic resolution is high and that the motion of the subject may appear jerky. In contrast, if the value of the difference signal is low, then it can be inferred that the dynamic resolution is low, and that motion may be blurry.

Consequently, when viewed from a dynamic resolution standpoint, it is preferable to increase the amount of feedback to lower the dynamic resolution when the value of the difference signal is large, while decreasing the amount of feedback to suppress lowered dynamic resolution when the value of the difference signal is small.

Meanwhile, in systems of the related art that conduct electrical shutter time control, the amount of noise reduction is specified by an operation to specify the shutter time (or by instructions for adjusting the dynamic resolution). Following the precedent of such systems of the related art, the present embodiment is also configured such that the specification of the amount of noise reduction and the dynamic resolution is conducted by means of an operation to specify the shutter time. In the configuration shown in FIG. 11, the control operations for suitably adjusting the amount of noise reduction (i.e., the dynamic resolution) according to a specified shutter time are assumed by the feedback characteristics configuration unit 44.

In FIG. 11, the feedback characteristics configuration unit 44 conducts a control such that feedback control characteristics are set in the feedback controller 43Y (as well as the feedback controller 43U and the feedback controller 43V) according to a shutter time value specified by a shutter time designation signal Ss supplied from the CPU 11 shown in FIG. 1. Herein, the shutter time designation signal Ss is issued from the CPU 11 to the feedback characteristics configuration unit 44 and contains a shutter time value that has been specified as a result of a user's input operation conducted via the operation input unit 13.

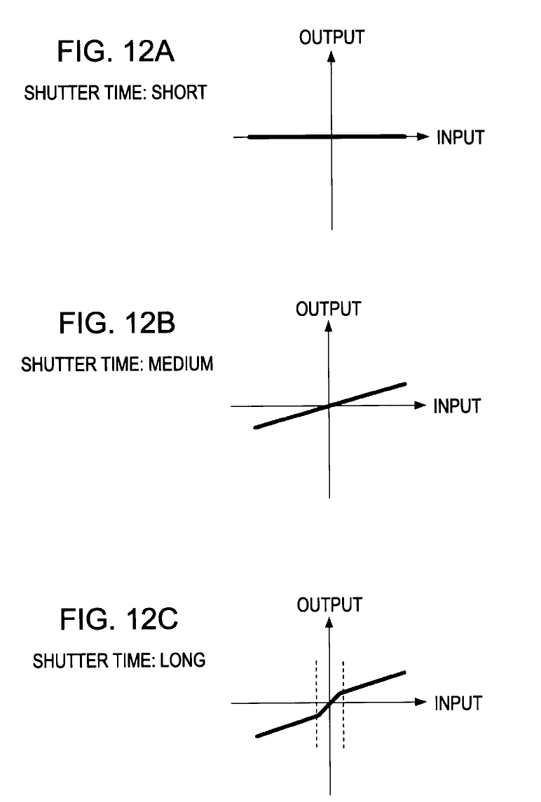

FIGS. 12A to 12C illustrate examples of control characteristics for the amount of feedback from a difference signal used by the feedback characteristics configuration unit 44 to configure the respective feedback controllers 43 according to a specified shutter time value.

FIG. 12A illustrates feedback control characteristics that are set in the case where the specified shutter time value corresponds to a Short setting. FIG. 12B illustrates feedback control characteristics that are set in the case where the shutter time corresponds to a Medium setting. FIG. 12C illustrates the feedback control characteristics that are set in the case where the shutter time corresponds to a Long setting.

It should be appreciated that feedback control characteristics herein refer to the transformation characteristics that express how the value of an output difference signal varies with the value of an input difference signal in the respective feedback controllers 43.

In FIG. 12A, “SHUTTER TIME: SHORT” refers to shutter times that are in the vicinity of the shortest shutter time with respect to the range of specifiable shutter times. In FIG. 12B, “SHUTTER TIME: MEDIUM” refers to shutter times that are in the vicinity of the median shutter time with respect to the range of specifiable shutter times. In FIG. 12C, “SHUTTER TIME: LONG” refers to shutter times that are in the vicinity of the longest shutter time with respect to the range of specifiable shutter times.

First, in the case where the specified shutter time corresponds to “SHUTTER TIME: MEDIUM” shown in FIG. 12B, the user's command is interpreted as being a neutral command with respect to both noise reduction and dynamic resolution. Consequently, in this case, the amount of feedback is preferably set so as to achieve a balance between noise reduction and dynamic resolution.

As described earlier, since the duration of the field for recording footage is set to a relatively short value in the present example, the dynamic resolution is already relatively high. For this reason, in order to obtain an intermediate dynamic resolution in such a state, feedback control characteristics are set having a predetermined slope when a Medium shutter time setting is specified, as shown in FIG. 12B. Doing so compensates for the already-high dynamic resolution, and enables an intermediate resolution to be obtained.

In addition, in the case where the specified shutter time corresponds to “SHUTTER TIME: SHORT” shown in FIG. 12A, the user's command can be interpreted as being a command to reduce motion blur. Consequently, in this case, control characteristics are set so as to obtain a constant amount of feedback regardless of the value of the input difference signal, as shown in FIG. 12A. More specifically, in this case, feedback control characteristics are set such that a constant value of 0 is returned as the output value for all input values.

By configuring the control characteristics so as to return a constant output value, advantages equivalent to decreasing motion blur are obtained, due to the dynamic resolution already being relatively high.

In addition, in the case where the specified shutter time corresponds to “SHUTTER TIME: LONG” shown in FIG. 12C, the user's command can be interpreted as being a command to obtain noise reduction effects. In this case, it is conceivable to further increase the slope of the control characteristics shown in FIG. 12B, and thereby set control characteristics whereby explicit noise reduction effects are obtained.

However, as can be understood from the foregoing description, when the slope is increased in this way to increase the amount of feedback, there also occurs an equivalent drop in dynamic resolution. Herein, noise reduction is desirable when the value of the difference signal is small and the amount of noise actually present is large. Consequently, in this case, the slope of the control characteristics is set to a larger value than that for the case of FIG. 12B in regions where the value of the difference signal is small, while the slope is decreased to a value similar to that for the case of FIG. 12B in regions where the value of the difference signal is large. In so doing, noise reduction effects are obtained that correspond to a command to increase the shutter time, while also enabling suppression of the undesirable side effect of motion blur.

Herein, the slope refers to the ratio of input to output values. In other words, the slope is the ratio of the value of a difference signal input into the feedback controller 43 versus the value of a difference signal output from the feedback controller 43. The specific value of the slope set in regions where the value of the difference signal is small is taken to be approximately 1:1.

Returning now to FIG. 11, when the feedback characteristics configuration unit 44 receives a shutter time designation signal Ss from the CPU 11 with a specified shutter time corresponding to a Short setting, then the feedback characteristics configuration unit 44 conducts a control such that feedback control characteristics like those shown in FIG. 12A are set in each feedback controller 43. When the shutter time designation signal Ss specifies a shutter time corresponding to a Medium setting, the feedback characteristics configuration unit 44 conducts a control such that feedback control characteristics like shown in FIG. 12B are set in each feedback controller 43. When the shutter time designation signal Ss specifies a shutter time corresponding to a Long setting, the feedback characteristics configuration unit 44 conducts a control such that feedback control characteristics like shown in FIG. 12C are set in each feedback controller 43.

Herein, the specific technique for setting feedback control characteristics in each feedback controller 43 may involve the following. For example, if the feedback controllers 43 are configured to realize feedback control characteristics by means of a function that expresses the relationship between the value of the input difference signal and the value of the output difference signal, then feedback control characteristics may be configured by issuing such a function to each feedback controller 43.

Alternatively, if the feedback controllers 43 are configured to realize feedback control characteristic by means of a table of associated values for input difference signals and output difference signals (i.e., a lookup table), then a command may be issued to each feedback controller 43 indicating which table information to use, thereby setting suitable feedback control characteristics according to shutter time.

It should be appreciated that even if the feedback controllers 43 are configured to output a difference signal with a value depending on the value of the input difference signal by using a table as described above, in effect the feedback controllers 43 are still applying a desired coefficient to an input difference signal and outputting the result.

By configuring feedback control characteristics according to a specified shutter time as described above, noise reduction effects are obtained that are equivalent to those that would result from increasing the shutter time, even though the actual shutter time is fixed. Moreover, it also becomes possible to ameliorate the tendency for subject motion to appear jerky as a result of the fixed shutter time.

In the noise reduction conducted by means of the shutter time control of the related art, increasing the noise reduction effects (i.e., increasing the shutter time) also introduces excessive motion blur into the recorded footage. However, according to the technique of the present example described above, by decreasing the characteristic slope as shown in FIG. 12C for the portions where the value of the difference signal is large, it becomes possible to prevent the introduction of excessive motion blur into the recorded footage. In other words, the technique of the present example represents an improvement over the shutter time control technique of the related art.

It should be appreciated that while the shutter time control processing described above is conducted after separating the image data into Y, U, and V components in the present embodiment, the above configuration allows for a reduction in the processing load associated with the shutter time control processing. More specifically, given a sampling ratio of Y:U:V=4:2:2 as described earlier, the sampling rate of the U image data and the V image data will normally be lower than that of the Y image data. Specifically, the U image data and the V image data will have a number of pixels that is one-half that of the Y image data. In other words, the processing load for shutter time control processing with respect to the U image data and the V image data can be reduced to approximately one-half that of the processing load for the shutter time control processing with respect to the Y image data.

Consider the hypothetical case wherein shutter time control processing similar to the above is conducted at the RGB stage. In this case, an equivalent processing load is exacted for the R, G, and B image data, respectively. In this respect, conducting shutter control processing after separation into Y, U, and V components allows for a reduction in processing load.

### (Processing Operations)

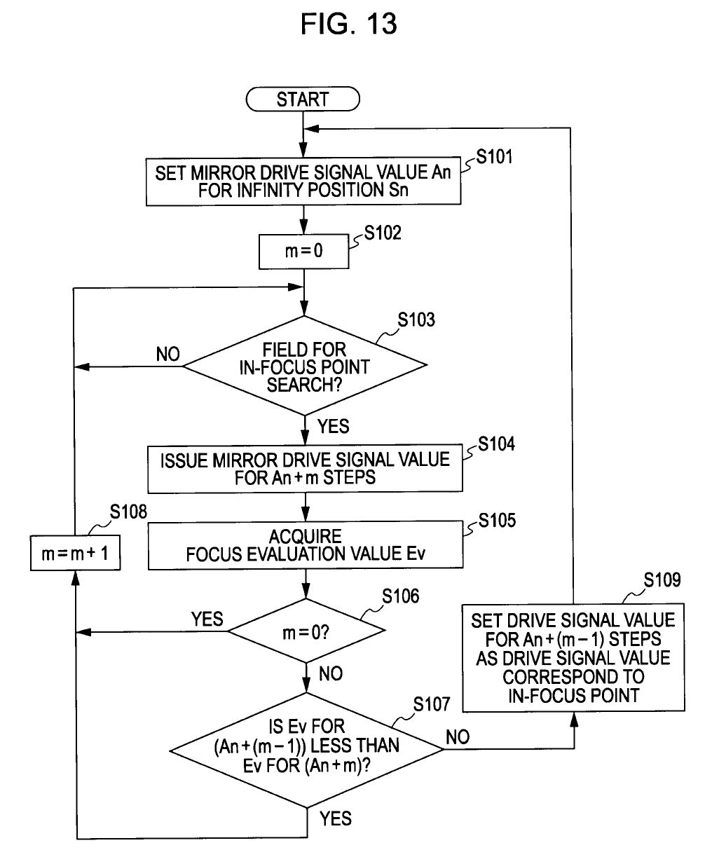

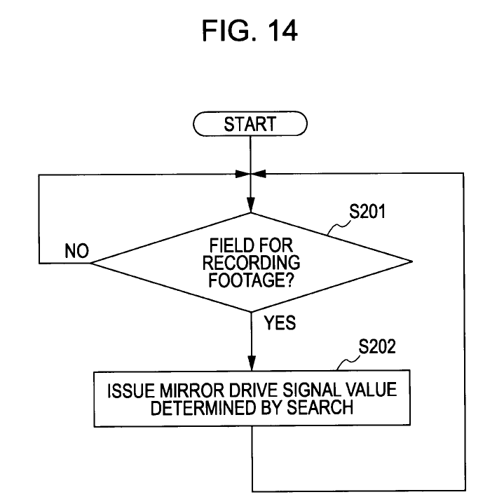

The processing operations conducted in order to realize the operation of the first embodiment as described in the foregoing will now be described with reference to the flowcharts in FIGS. 13 and 14. The processing operations shown in FIGS. 13 and 14 are executed by the CPU 11 on the basis of a program stored in the memory 12 shown in FIG. 1.

FIG. 13 illustrates the processing operations to be executed primarily in accordance with the image reading periods for the fields for in-focus point search (i.e., the processing to find an in-focus point using a hill climbing technique). FIG. 14 illustrates the processing operations to be executed in accordance with the image reading periods for the fields for recording footage.

First, in step S101 of FIG. 13, the mirror drive signal value (herein taken to be An) for adjusting the focal position to the infinity position Sn is set. In the subsequent step S102, processing is executed to reset the value of a step number count value m to 0. As can be understood from the following description, the step number count value m is used by the CPU 11 to count the step number of a mirror drive signal value when adjusting the focal point to various points for in-focus point search.

In the subsequent step S103, the process waits until a field for in-focus point search is reached. When a field for in-focus point search is reached, processing is conducted to issue a mirror drive signal value equal to An plus m steps. More specifically, a mirror drive signal value equal to the sum of the mirror drive signal value An set in the previous step S101 and a value equivalent to m steps is issued to the mirror drive circuit 8 shown in FIG. 1. As a result, the shape of the mirror surface in the deformable mirror apparatus 2 deforms so as to obtain the focal position defined by the mirror drive signal value equal to An plus m steps.

In the subsequent step S105, one or more evaluation values Ev are acquired. More specifically, one or more evaluation values Ev are acquired as a result of calculation by the focus evaluation value calculator 27 in the signal processor 6.

In the subsequent step S106, it is determined whether or not m=0. In other words, it is determined whether or not an evaluation value Ev was only acquired for the infinity position Sn. If it is determined that m=0 and a positive result is obtained indicating that an evaluation value Ev was only acquired for the infinity position Sn, then the process proceeds to step S108 as shown in FIG. 13, the step number count value m is incremented (m=m+1), and then the process returns to the previous step S103. In so doing, an evaluation value Ev can be acquired for the next focal position.

Meanwhile, if it is determined in step S106 that m≠0 and a negative result is obtained indicating that evaluation values Ev were acquired for not just the infinity position Sn, then the process proceeds to step S107. In step S107, it is determined whether or not the evaluation value Ev for a mirror drive signal value of (An+m) is greater than the evaluation value Ev for (An+(m−1)). At this point, if the evaluation value Ev for (An+m) is greater, then the evaluation value Ev for the newly-adjusted focal point is the greater of the compared values, while if the evaluation value Ev for (An+m) is smaller, then the evaluation value Ev for the newly-adjusted focal point is the smaller of the compared values.

If a positive result is obtained in step S107 indicating that the evaluation value Ev for (An+m) is the greater of the compared values, then the process proceeds to step S108, the step number count value m is incremented, and then the process returns to step S103.

On the other hand, if a negative result is obtained in step S107 indicating that the evaluation value Ev for (An+m) is not the greater of the compared values, then the process proceeds to step S109, and processing is conducted to set the mirror drive signal value that is equal to An plus (m−1) steps as the drive signal value corresponding to the in-focus point.

Upon completion of the processing in step S109, the process returns to step S101, as shown in FIG. 13, thereby causing the in-focus point search to be repeated.

It should be appreciated that the series of processing operations shown in FIG. 13 may also be terminated in response to the occurrence of a trigger set in advance as an indicator to stop recording footage. For example, the trigger may be an input operation to switch the power off, or an input operation issuing a command to abort recording operations. More specifically, the CPU 11 operates in parallel with the processing operations shown in FIG. 13 and determines whether or not a trigger to stop recording footage (such as the above power off operation or abort operation) has occurred. If the result of the determination indicates that an abort trigger has occurred, then the processing operations shown in FIG. 13 are terminated.

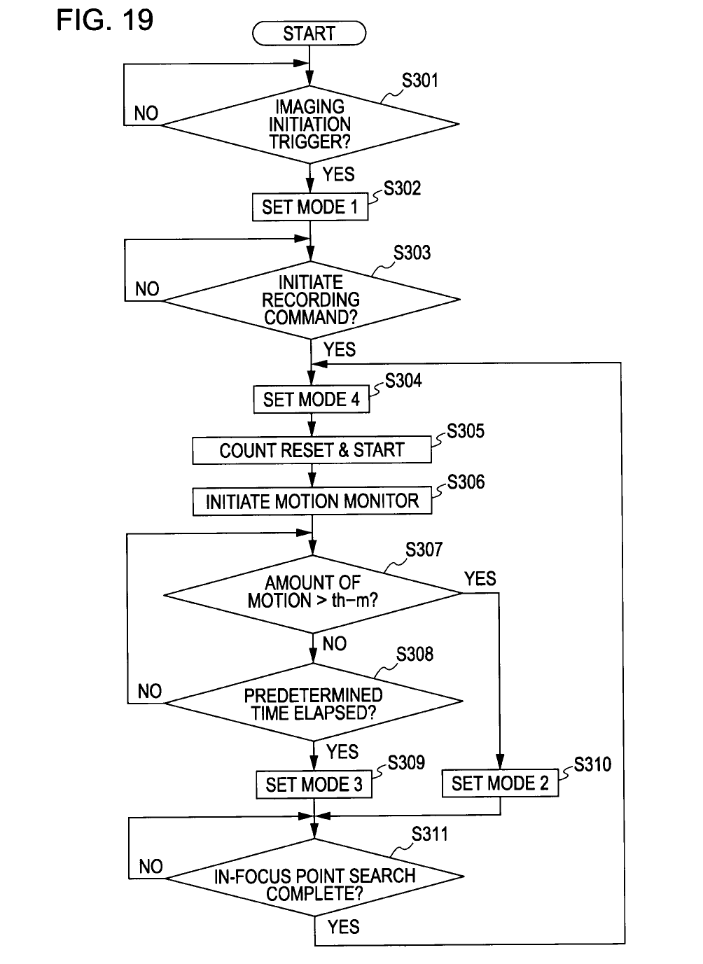

The above termination of processing operations in response to the occurrence of an abort trigger is similarly applied to the processing operations shown in FIG. 14 as well as to the processing operations shown in FIG. 19.

In addition, the CPU 11 also operates in parallel with the processing operations shown in FIG. 13 and executes the processing operations shown in FIG. 14. FIG. 14 illustrates the processing operations corresponding to the image reading periods for the fields for recording footage.

In step S201 of FIG. 14, processing is executed to wait until a field for recording footage is reached. When a field for recording footage is reached, processing is executed in step S202 whereby a mirror drive signal value that has been determined by search is issued. More specifically, processing is executed to issue a mirror drive signal value to the mirror drive circuit 8 as the in-focus point that is determined in a continuously updated manner as a result of the processing in step S109 of FIG. 13. As a result, the reading of video images is conducted in an focused state in the fields for recording footage. Upon execution of the processing in step S202, the process returns to step S201. In so doing, video images are read in a focused state for each field for recording footage.

### Second Embodiment

A second embodiment will now be described. In the second embodiment, the frame periods are set to durations shorter than that of typical frame periods. In addition, the image reading period for the frame for recording footage and the image reading period for the frame for in-focus point search are differentiated by frame period.

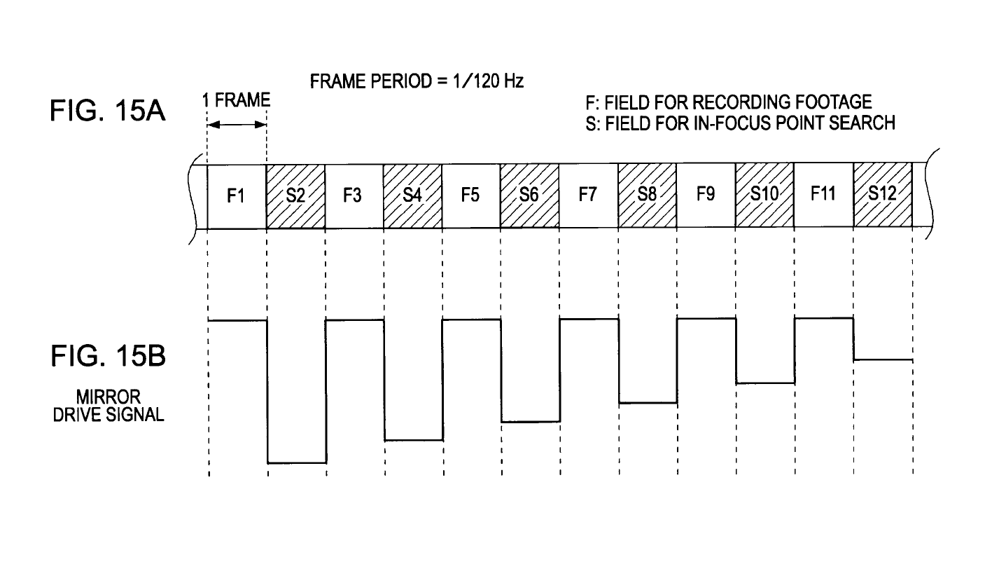

FIGS. 15A and 15B are diagrams for explaining the concept of frame differentiation like that of the second embodiment. FIG. 15A illustrates the allocation of individual image reading readings, while FIG. 15B illustrates exemplary waveforms of the mirror drive signal.

As shown in FIG. 15A, the frame period in the second embodiment is set to a shorter duration than the frame period of the first embodiment (wherein the frame period is equal to the inverse of a frame frequency of 30 Hz). More specifically, the frame period in the present case corresponds to a frame frequency of 120 Hz. Furthermore, the image reading periods are allocated such that both the image reading periods for the frames for recording footage (designated F in the figure) and the image reading periods for the frames for in-focus point search (designated S in the figure) respectively have the length of a single frame period.

As can be seen with reference to FIG. 15B, in the above case, the deformable mirror apparatus 2 is still driven so as to be adjusted to focal points used to find in-focus points during the image reading periods for the frames for in-focus point search, and the deformable mirror apparatus 2 is still driven so as to be adjusted to an in-focus point during the image reading periods for the frames for recording footage.

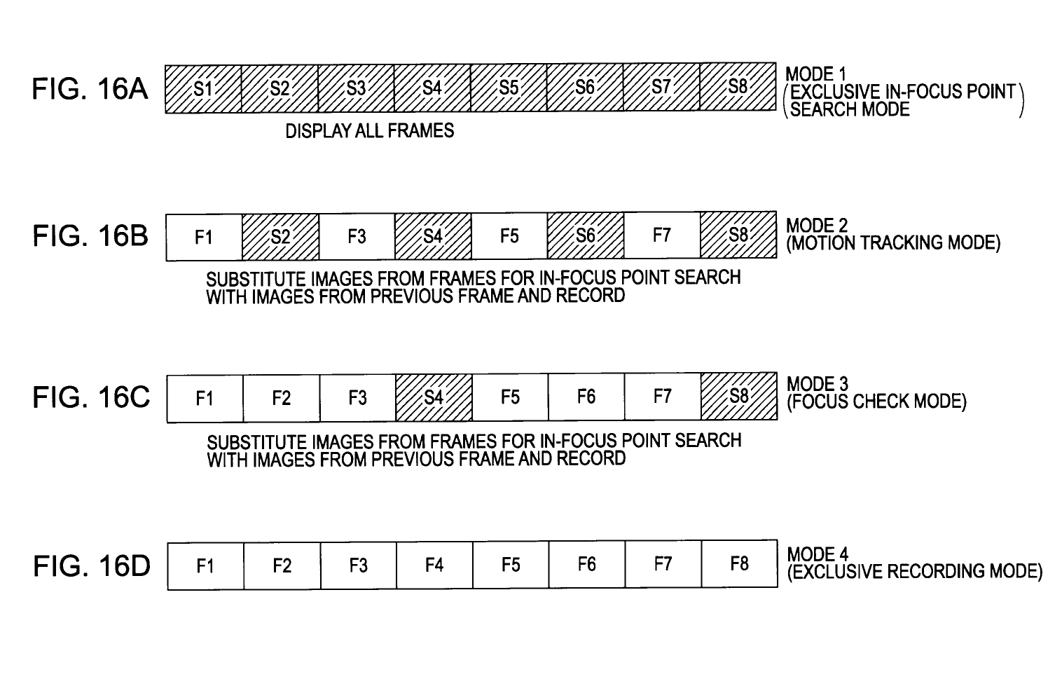

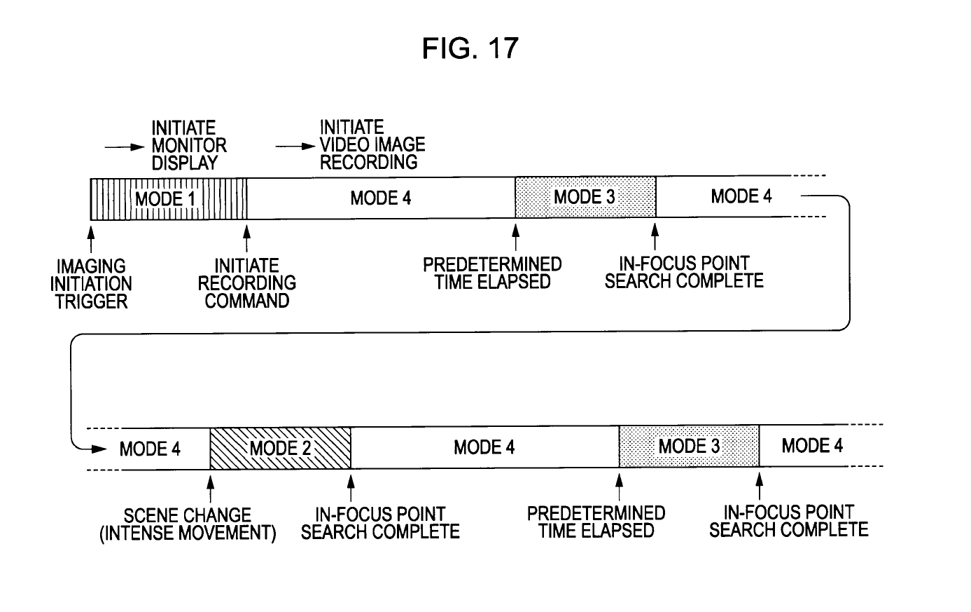

As described above, the second embodiment is premised upon the following two features. Firstly, the frames for recording footage and the frames for in-focus point search have respective durations equal to that of a single frame period. Secondly, the deformable mirror apparatus 2 is adjusted to focal points used to find an in-focus point in the frames for in-focus point search, and additionally adjusted to such an in-focus point in the frames for recording footage. On the basis of the above, a plurality of modes as illustrated in FIGS. 16A to 16D are defined as modes for image reading. In addition, as shown in FIG. 17, the recording of video image data is conducted while appropriately switching among such a plurality of image reading modes.

In FIGS. 16A to 16D, four modes are defined as the image reading modes in the present case: Mode 1, Mode 2, Mode 3, and Mode 4. More specifically, Mode 1 shown in FIG. 16A is an exclusive in-focus point search mode, with all frames therein being frames for in-focus point search. The image data read in the frames for in-focus point search in this case are only used to find in-focus points (i.e., to calculate focus evaluation values Ev). Thus the above image data is not recorded. The image data is still displayed, however. In Mode 1, the search for an in-focus point is repeatedly conducted.

Mode 2 shown in FIG. 16B is a motion tracking mode, with image reading being conducted as a repeated alternation between a frame for recording footage and a frame for in-focus point search. Mode 2 is terminated when the processing to find an in-focus point is completed.

In addition, in Mode 2, images from respective frames for in-focus point search are substituted with the immediately previous frame image before recording. In other words, if it is assumed in this case that 120 frame images per second are recorded, the frame images are interpolated as described above.

Mode 3 shown in FIG. 16C is a focus check mode, wherein a frame for in-focus point search is inserted at an interval occurring every several frames. In the present case, for example, one frame for in-focus point search is inserted for every three frames for recording footage. Mode 3 is also terminated when the processing to find an in-focus point is completed. In addition, in Mode 3, the images from respective frames for in-focus point search are substituted with the immediately previous frame image.

Mode 4 shown in FIG. 16D is an exclusive recording mode, wherein image reading is conducted with all frames being frames for recording footage.

The switching of the above modes is conducted as shown in FIG. 17. Herein, it is assumed that when recording video, the user first performs an operation to turn on the power or to switch from a playback mode to a recording mode, whereby the imaging apparatus transitions to a recording standby state. In the recording standby state, monitor display of captured footage is initiated. Subsequently, when an operation for initiating recording is conducted while in the recording standby state, recording of footage is initiated.

In FIG. 17, Mode 1 shown in FIG. 16A (i.e., the exclusive in-focus point search mode) is set corresponding to the recording standby state described above. Mode 1 is set in response to the occurrence of an imaging initiation trigger, such as the operation to turn on the power or to switch from a playback mode to a recording mode as described above.

After setting Mode 1, if an initiate recording command is issued as a result of an operation for initiating recording, then Mode 4 shown in FIG. 16D (i.e., the exclusive recording mode) is set in response.

Subsequent to setting Mode 4 in response to the initiation of recording as above, Mode 4 may be switched to either Mode 2 (i.e., the motion tracking mode) or Mode 3 (i.e., the focus check mode) in response to the success or failure to satisfy predetermined conditions.

More specifically, if the amount of movement in an image exceeds a predetermined amount while Mode 4 is set, then the mode may be switched to Mode 2. In so doing, the mode is switched to a mode wherein frames for in-focus point search are inserted at relatively shorter intervals as a response to the development of a state of intense subject movement. The amount of movement described above may be found using the magnitude of the inter-frame difference signal. When the in-focus point search processing is executed in Mode 2 and the in-focus point search is completed, the mode may once again be set to Mode 4.

On the other hand, if a predetermined amount of time set in advance elapses while in Mode 4 without the amount of movement exceeding the predetermined amount, then the mode may be set to Mode 3. In other words, in-focus point search and focal point reconfiguration may be conducted at set time intervals even during a sustained state of non-intense movement. Upon completion of the in-focus point search after setting Mode 3, the mode may once again be set to Mode 4.

As described with reference to FIG. 17, in-focus point search is conducted by means of an exclusive in-focus point search mode (i.e., Mode 1) while in a standby state before recording is initiated. As a result, a focused state is already achieved by the time recording is actually initiated. Moreover, by switching among Mode 4, Mode 3, and Mode 2 after initiating recording, any decreases in the fidelity of the recorded video due to the image substitutions accompanying the insertion of frames for in-focus point search can be kept to a minimum.

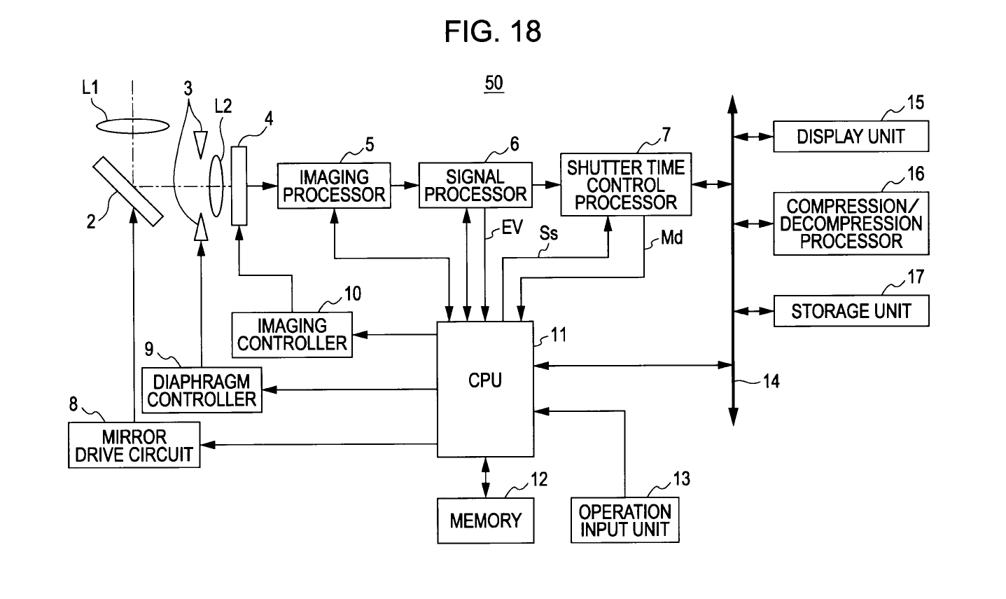

The configuration of an imaging apparatus 50 for realizing the operation of the second embodiment as described in the foregoing will now be described with reference to FIG. 18. The portions in FIG. 18 that have already been described with reference to FIG. 1 are referred to using identical symbols, and further description thereof herein is omitted for the sake of brevity.

Upon comparison with the imaging apparatus 1 shown in FIG. 1, the imaging apparatus 50 in the present case differs in that a motion detection signal Md is supplied to the CPU 11 from the shutter time control processor 7. Although not shown in the drawings, the shutter time control processor 7 in the present case is configured such that the difference signal for each frame image obtained by the subtractor 42Y is split and subsequently supplied to the CPU 11 as the motion detection signal Md.

The CPU 11 then compares the value of the motion detection signal Md supplied as above to the value of a set amount of motion determined in advance. On the basis of comparison result, the CPU 11 determines whether or not the amount of motion is equal to or greater than the predetermined amount.

Although the imaging apparatus 50 of the second embodiment is also provided with a shutter time control processor 7, in the second embodiment the frame period is set to a shorter duration, and thus the dynamic resolution is high by default, similarly to the first embodiment. Consequently, a shutter time control processor 7 is also provided in the second embodiment as shown in FIG. 18, and by setting feedback control characteristics as described with reference to FIGS. 12A to 12C, advantages similar to those of the first embodiment are obtained.

### (Processing Operations)

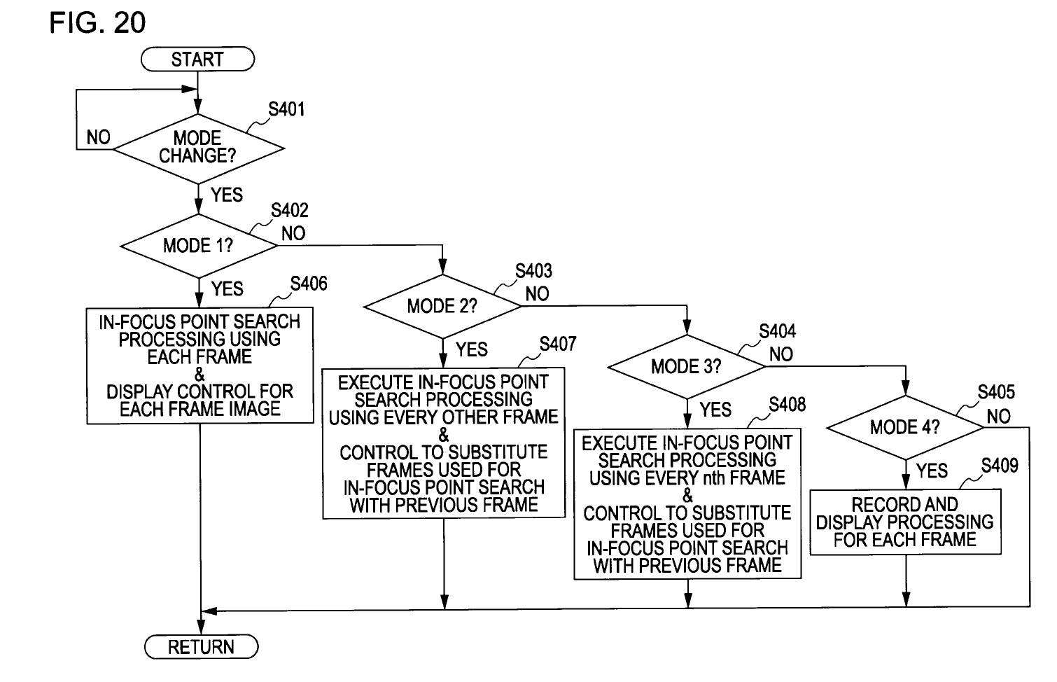

The processing operations executed in order to realize the operation of the second embodiment described above will now be described with reference to the flowcharts in FIGS. 19 and 20. The processing operations shown in FIGS. 19 and 20 are executed by the CPU 11 shown in FIG. 18 on the basis of a program stored in the memory 12.

FIG. 19 illustrates the processing operations executed in order to switch among the various modes described with reference to FIG. 17. In step S301, processing is executed to wait for the occurrence of an imaging initiation trigger. More specifically, the process waits for the occurrence of a pre-defined trigger for transitioning to the recording standby state, the trigger herein being the above-described operation to turn on the power or switch to a recording mode conducted by means of an input operation via the operation input unit 13, for example. When an imaging initiation trigger occurs, processing is executed to set Mode 1 in step S302.

In the subsequent step S303, processing is executed to wait until an initiate recording command is issued. More specifically, the process is configured to wait until an input operation issuing an initiate recording command is conducted via the operation input unit 13. Subsequently, upon receiving an initiate recording command, the mode is set to Mode 4 in step S304.

In the subsequent step S305, processing is executed to reset and start a count. More specifically, processing is executed to reset and start a time count value used to count the amount of time elapsing from the point at which Mode 4 is set. In addition, in the following step S306, motion monitoring is initiated. More specifically, monitoring is initiated with respect to the value of the motion detection signal Md supplied from the shutter time control processor 7.

In the subsequent step S307, it is determined whether or not the amount of motion is equal to or greater than a predetermined amount of motion th-m. In step S307, if a negative result is obtained indicating that the value of the motion detection signal Md acquired from the shutter time control processor 7 (more specifically, from the subtractor 42Y therein) is not equal to or greater than the predetermined amount of motion th-m, then the process proceeds to step S308, where it is determined whether or not a predetermined amount of time has elapsed. In step S308, if a negative result is obtained indicating that the elapsed time count value of the count initiated in the above step S305 has not reached a predetermined value (and thus the predetermined amount of time has not elapsed), then the process returns to step S307. As a result of the above process loop that proceeds from step S307 to step S308 and then back to step S307, the process is configured to wait until either the amount of motion becomes equal to or greater than a predetermined amount, or until a predetermined amount of time has elapsed.

In the above step S307, if a positive result is obtained indicating that the acquired value of the motion detection signal Md has become equal to or greater than the predetermined amount of motion th-m, then the process proceeds to step S310, the mode is set to Mode 2, and then the process subsequently proceeds to step S311.

On the other hand, in the above step S308, if a positive result is obtained indicating that the count value has reached the predetermined value and thus the predetermined amount of time has elapsed, then the process proceeds to step S309, the mode is set to Mode 3, and then the process subsequently proceeds to step S311.

In step S311, processing is executed to wait until in-focus point search is completed. More specifically, the process is configured to wait until the in-focus point search conducted in either Mode 2 or Mode 3 is completed. Upon completion of the in-focus point search, the process returns the previous step S304 shown in FIG. 19, and a result the mode is once again set to Mode 4.

FIG. 20 illustrates the processing operations for realizing the operations of the respective modes. First, in step S401, the process waits until the occurrence of a mode change. More specifically, processing is executed to wait until the mode configuration processing from any of steps S302, S304, S309, and S310 is conducted.

When a mode change occurs, the processing in steps S402, S403, S404, and S405 shown in FIG. 20 is executed, whereby it is determined whether or not the mode is set to Mode 1 (S402), Mode 2 (S403), Mode 3 (S404), or Mode 4 (S405).

In step S402, if a positive result is obtained indicating that the mode is set to Mode 1, then the process proceeds to step S406, and in-focus point search processing is conducted using all frames, as well as display control processing being executed for each frame.

In this case, the in-focus point search processing itself is similar to that shown in FIG. 13, except that the fields for in-focus point search have become frames for in-focus point search. The above is also true for the in-focus point search processing conducted in steps S407 and S408 to be hereinafter described.

In addition, the display control processing is configured such that image data based on an image signal read during a given frame period is supplied to the display unit 15 after having been processed by the imaging processor 5, the signal processor 6, and the shutter time control processor 7, in that order. Subsequently, instructions are issued to the display unit 15 to display the processed image data.

In step S403, if a positive result is obtained indicating that the mode is set to Mode 2, then the process proceeds to step S407, in-focus point search processing using every other frame is executed, and in addition, control processing is executed whereby the frames used for in-focus point search are substituted with the respective frames immediately previous thereto. The frame substitution processing conducted in step S407 is executed by the video frame interpolation processor 24.

In addition, in this case, the CPU 11 conducts a control whereby the post-substitution image data is compressed by the compression/decompression processor 16 and then recorded in the storage unit 17. In addition, in order to display video in real-time, the post-substitution image data is also supplied to the display unit 15 and subsequently displayed.

In step S404, if a positive result is obtained indicating that the mode is set to Mode 3, then the process proceeds to step S408, in-focus point search processing is executed using every nth frame (in the present case, every third frame), and in addition, control processing is executed whereby the frames used for in-focus point search are substituted with the respective frames immediately previous thereto.

The frame substitution processed in step S408 is also executed by the video frame interpolation processor 24. Also in this case, the CPU 11 conducts a control whereby the post-substitution image data is compressed by the compression/decompression processor 16 and then recorded in the storage unit 17. In addition, in order to display video in real-time, the post-substitution image data is also supplied to the display unit 15 and subsequently displayed.

In step S405, if a positive result is obtained indicating that the mode is set to Mode 4, then the process proceeds to step S409, whereby recording and display processing is executed for each frame. In other words, all frames are recorded and displayed without conducting read operations for in-focus point search.

### Modifications

Although embodiments of the present invention have been described in the foregoing, it should be appreciated that the present invention is not limited to the specific examples described in the foregoing.

For example, the deformable mirror apparatus is not limited to the configuration described with reference to FIG. 3, and instead a variety of configurations are conceivable. For example, the various configurations disclosed in literature previously submitted by the inventors may also be used (see JP-A-2006-155850). Alternatively, the deformable mirror apparatus disclosed in JP-A-2004-170637 as noted earlier may also be used. So long as the focal point is changed as a result of the shape of a mirror surface being deformed to convex or concave curvature in response to a given driving force applied thereto, the specific configuration of the deformable mirror used in the present invention is not limited.

In addition, in the foregoing, a configuration was described by way of example wherein the signal processor 6 and the shutter time control processor 7 are provided separately. However, the signal processor 6 and the shutter time control processor 7 may also be configured as a single integrated circuit.

In addition, the foregoing described, by way of example, the case wherein CMOS sensors are used as the imaging elements 4 for reasons relating to the partial reading of the fields (or frames) for in-focus point search. However, in the case where such partial reading is not conducted, for example, CCD (Charge-Coupled Device) sensors may also be used.

In addition, the foregoing described, by way of example, the case wherein the lenses are formed in an integrated manner with the imaging apparatus (i.e., the imaging apparatus 1 or the imaging apparatus 50). However, the present invention may also be favorably applied to a configuration like that of a single lens reflex camera, wherein the lens portion is removably attached to the main body of the apparatus.

If the lens portion is configured to be removable as described above, then both a configuration wherein the deformable mirror is provided in the main body of the camera (as part of the pentaprism portion, for example) as well as a configuration wherein the deformable mirror is provided in the lens portion are conceivable. The present invention may be favorably applied to either of the above configurations. The focus control processing itself may be the same in either case, with the only difference being whether the subject of the control is a deformable mirror provided in the main body of the imaging apparatus, or a deformable mirror provided in the lens portion.

In addition, the foregoing describes, by way of example, the case wherein the present invention is applied to an imaging system that records video. However, the present invention may also be favorably applied for use in the recording of still images.

Even in the case of recording still images, video may be imaged in order to produce a real-time display of imaged content. When obtaining video in this way, frames (or fields) for in-focus point search may be set using a technique similar to that described in the foregoing. By switching the focus drive state between a frame for recording footage and a frame for in-focus point search, in-focus point search processing can be repeatedly executed using the evaluation results from the frames for in-focus point search.

In an imaging apparatus of the related art that records still images, AF (autofocus) operations may be executed upon receiving an AF command as a result of, for example, the user partially depressing a shutter button used to issue a command to record a still image. If AF operations are conducted during the real-time display as in the technique described above, a focused state can be immediately achieved in response to the AF command, thereby making it possible to reduce the amount of time involved in AF.

Moreover, since frames for recording footage and frames for in-focus point search are differentiated in the above technique, the above has the advantage of not displaying unfocused footage resulting from varying the focal position during the real-time display.

In addition, the foregoing describes, by way of example, the case wherein video footage is recorded as a data file (i.e., digital data) that has been compressed in accordance with the MPEG standard, for example. However, the present invention may also be favorably applied to the case wherein an analog video signal is recorded.

In addition, the in-focus point search processing described in the foregoing is configured such that, when the evaluation value Ev of the focal point currently being tested becomes less than that of the immediately previous focal point, the in-focus point is determined to be the immediately previous focal point. However, it should be appreciated that the foregoing describes the simplest processing example only for the sake of convenience, and that more complex processing such as that used in actual practice may also be executed.

For example, an in-focus point search range may be defined in advance, and an evaluation value Ev may be acquired when testing an individual focal point within the search range. In this case, since the evaluation values Ev vary positively, a technique may be adopted wherein, upon finding a point at which the slope of the focus evaluation values Ev changes from increasing to decreasing, linear approximations are calculated for the evaluation values Ev obtained at the neighboring points, and wherein the in-focus point is subsequently determined to be the point at which the two lines thus obtained intersect. By implementing a technique using approximations like the above example, a more accurate in-focus point can be found.

In addition, in the first embodiment in particular, an image reading period for in-focus point search is inserted into the first image reading period of the related art. In order to realize the above, the imaging processing and image signal processing of the related art may be modified. For example, in some cases the processing subsequent to that corresponding to the imaging processor 5 of the related art may be configured such that, upon acquiring a field image during the first field period, further processing is suspended. In such a case, even though an image reading period is inserted as a field for in-focus point search, only the result from the field for recording footage prior to the field for in-focus point search becomes subject to further processing. As a result, the image read from the field for in-focus point search is no longer forwarded for subsequent processing.

For example, if the present example is applied to a system provided with a suspension period as above, then the portions of the configuration used to obtain a focus evaluation value Ev may be inserted directly after image reading is conducted within the imaging processor 5. More specifically, a functional unit may be inserted to calculate a focus evaluation value on the basis of the high-frequency signal portions of the respective R, G, and B image data. In so doing, the focal control technique of the present invention may be realized without further modifying the portion of the configuration subsequent to the imaging processor 5.

It should be understood by those skilled in the art that various modifications, combinations, sub-combinations and alterations may occur depending on design requirements and other factors insofar as they are within the scope of the appended claims or the equivalents thereof.

What is claimed is:

1. A focus control apparatus that conducts a focus control with respect to an imaging apparatus configured to vary the focal point using a deformable mirror, provided as part of the imaging optics thereof, whose cross-sectional shape is deformable to convex or concave curvature, the focus control apparatus comprising:
imaging means for obtaining image data that has been imaged as a result of imaging elements detecting an image formed via the imaging optics; and
control means for conducting a drive control with respect to the deformable mirror such that, during a first image reading period wherein the reading of an image signal is periodically executed by means of the imaging elements, the control means controls the driving of the deformable mirror so as to achieve a focus drive state whereby an in-focus point that has been found in advance is set as the current focal point, and additionally, during a second image reading period different from the first image reading period, the control means controls the driving of the deformable mirror so as to achieve a focus drive state for use when searching for an in-focus point.

2. The focus control apparatus according to claim 1, further comprising:
recording means for recording data to a recording medium;
wherein the control means conducts a control such that image data based on an image signal read during the first image reading period is recorded by the recording means.

3. The focus control apparatus according to claim 2, further comprising:
feedback means for solving for a difference signal for each set of image data based on an image signal read by the imaging elements, applying to the difference signal a coefficient that varies according to the magnitude of the difference signal, and then subtracting the resulting difference signal from the image data in order to provide feedback;
wherein the duration of the first image reading period is fixed.

4. The focus control apparatus according to claim 3, wherein the feedback means varies the input and output characteristics of the difference signal according to a shutter time value issued as a result of command input.

5. The focus control apparatus according to claim 4, wherein, after separating the image data into Y, U, and V components, the difference signal feedback processing is separately executed with respect to the individual image data components.

6. The focus control apparatus according to claim 1, wherein the first image reading period and the second image reading period are configured so as to be inserted during the same field period or the same frame period.

7. The focus control apparatus according to claim 6, wherein the duration of the second image reading period is configured to be shorter than the duration of the first image reading period.

8. The focus control apparatus according to claim 7, further comprising:
recording means for recording data to a recording medium;
wherein the control means conducts a control such that image data based on an image signal read during the first image reading period is recorded by the recording means.

9. The focus control apparatus according to claim 8, further comprising:
feedback means for solving for a difference signal for each set of image data based on an image signal read by the imaging elements, applying to the difference signal a coefficient that varies according to the magnitude of the difference signal, and then subtracting the resulting difference signal from the image data in order to provide feedback;
wherein the duration of the first image reading period is fixed.

10. The focus control apparatus according to claim 9, wherein the feedback means varies the input and output characteristics of the difference signal according to a shutter time value issued as a result of command input.

11. The focus control apparatus according to claim 10, wherein, after separating the image data into Y, U, and V components, the difference signal feedback processing is separately executed with respect to the individual image data components.

12. The focus control apparatus according to claim 1, wherein the first image reading period and the second image reading period are divided into frame period units.

13. The focus control apparatus according to claim 12, wherein the control means controls the deformable mirror by switching among
a first mode, wherein the deformable mirror is controlled so as to obtain a focus drive state for conducting in-focus point search in all frame periods,
a second mode, wherein the deformable mirror is controlled so as to obtain a focus drive state for conducting in-focus point search in every other frame period,
a third mode, wherein the deformable mirror is controlled so as to obtain a focus drive state for conducting in-focus point search at an interval equal to a predetermined number of frame periods, and
a fourth mode, wherein the deformable mirror is controlled so as to obtain a focus drive state for setting the focus point in all frame periods to a focal point determined in advance as an in-focus point.

14. The focus control apparatus according to claim 13, further comprising:
recording means for recording data to a recording medium;
wherein
during the fourth mode, the control means conducts a control such that the frame image data obtained in all frame periods is recorded by the recording means, and
during the second and third modes, the control means conducts a control such that the frame image data obtained in the frame periods during which mirror control was conducted for in-focus point search is substituted with the frame data obtained in the immediately previous frame period.

15. The focus control apparatus according to claim 14, further comprising:
motion detection means for detecting an amount of motion from the value of a difference signal for each set of image data based on an image signal read by the imaging elements;
wherein the control means sets the mode to the first mode in response to the occurrence of an imaging initiation trigger, to the fourth mode in response to a command to initiate recording of the image data using the recording means, to the third mode in response to an amount of time elapsing after setting the fourth mode, and to the second mode in response to an amount of motion being detected by the motion detection means.

16. The focus control apparatus according to claim 15, wherein the frame period is set to a value corresponding to a frame frequency of 120 Hz.

17. The focus control apparatus according to claim 16, further comprising:
feedback means for solving for a difference signal for each set of image data based on an image signal read by the imaging elements, applying to the difference signal a coefficient that varies according to the magnitude of the difference signal, and then subtracting the resulting difference signal from the image data in order to provide feedback.

18. The focus control apparatus according to claim 17, wherein the feedback means varies the input and output characteristics of the difference signal according to a shutter time value issued as a result of command input.

19. The focus control apparatus according to claim 18, wherein, after separating the image data into Y, U, and V components, the difference signal feedback processing is separately executed with respect to the individual image data components.

20. A focus control method, whereby a focus control is conducted with respect to an imaging apparatus configured to vary the focal point using a deformable mirror, provided as part of the imaging optics thereof, whose cross-sectional shape is deformable to convex or concave curvature, the focus control method comprising the steps of:
during a first image reading period wherein the reading of an image signal is periodically executed by means of imaging elements that detect an image formed via the imaging optics, controlling the driving of the deformable mirror so as to achieve a focus drive state whereby an in-focus point that has been found in advance is set as the current focal point; and
during a second image reading period different from the first image reading period, controlling the driving of the deformable mirror so as to achieve a focus drive state for in-focus point search.

21. A focus control apparatus that conducts a focus control with respect to an imaging apparatus configured to vary the focal point using a deformable mirror, provided as part of the imaging optics thereof, whose cross-sectional shape is deformable to convex or concave curvature, the focus control apparatus comprising:
an imaging unit configured to obtain image data that has been imaged as a result of imaging elements detecting an image formed via the imaging optics; and
a controller configured to conduct a drive control with respect to the deformable mirror such that, during a first image reading period wherein the reading of an image signal is periodically executed by means of the imaging elements, the control means controls the driving of the deformable mirror so as to achieve a focus drive state whereby an in-focus point that has been found in advance is set as the current focal point, and additionally, during a second image reading period different from the first image reading period, the control means controls the driving of the deformable mirror so as to achieve a focus drive state for use when searching for an in-focus point.
